(19) United States
(12) Patent Application Publication
(10) Pub. No.: US 2026/0218008 A1
(43) Pub. Date: Jul. 30, 2026

(54) COMPOUND, COMPOSITION, SURFACE TREATMENT AGENT, ARTICLE, METHOD FOR MANUFACTURING ARTICLE, AND INTERMEDIATE

(71) Applicant: AGC Inc., Tokyo (JP)

(72) Inventors: Yosuke TAKEDA, Tokyo (JP); Koki WATANABE, Tokyo (JP)

(73) Assignee: AGC Inc., Tokyo (JP)

(21) Appl. No.: 19/577,603

(22) Filed: Mar. 25, 2026

Related U.S. Application Data
(63) Continuation of application No. PCT/JP2024/033863, filed on Sep. 24, 2024.

(30) Foreign Application Priority Data
Sep. 27, 2023 (JP) 2023-166268

(51) Int. Cl. C09D 183/06; C07F 7/08; C07F 7/18; C07F 7/21; C08G 77/18; C08G 77/26

(52) U.S. Cl. CPC C09D 183/06; C07F 7/0812; C07F 7/1804; C07F 7/21; C08G 77/18; C08G 77/26

(57) ABSTRACT

A new compound or the like capable of forming a surface-treated layer with excellent abrasion resistance is provided. A compound according to the present disclosure is a compound comprising a group P shown below and an organopolysiloxane residue. Group P: —[Si(R¹)₂—X]ₙ₁—Si(R¹)₃ where: each X is independently an oxygen atom or a carbon atom; each R¹ is independently a hydrolyzable group, a group having a hydrolyzable group, a hydroxyl group, or a hydrocarbon group; at least four of R¹ are hydrolyzable groups, groups having a hydrolyzable group, or hydroxyl groups; and n1 is an integer of 1 to 3.

### INCORPORATION BY REFERENCE

This application is based upon and claims the benefit of priority from Japanese patent application No. 2023-166268, filed on Sep. 27, 2023, and PCT application No. PCT/JP2024/033863 filed on Sep. 24, 2024, the disclosure of which is incorporated herein in its entirety by reference.

### BACKGROUND

The present disclosure relates to a compound, a composition, a surface treatment agent, an article, a method for manufacturing an article, and an intermediate.

In recent years, there has been a demand for a technique prevent fingerprint adhesion to the surface of an article and to facilitate the removal of contaminants (e.g., smudges) in order to improve properties of the article such as its appearance and visibility. As a specific method, a method for treating the surface of an article by using a surface treatment agent is known.

International Patent Publication No. WO2023/017830 discloses a specific siloxane group-containing silane compound having a divalent linear organopolysiloxane group and a hydrolyzable silyl group.

### SUMMARY

It has been desired to further improve surface treatment agents in view of their abrasion resistance and the like.

The present disclosure has been made in view of the above-described circumstances, and an object thereof is to provide a novel compound or the like capable of forming a surface-treated layer with excellent abrasion resistance.

The present disclosure includes the following aspects.

[1]

A compound comprising:
a group P shown below; and
an organopolysiloxane residue,

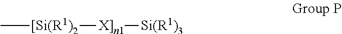

where
each X is independently an oxygen atom or a carbon atom,
each R¹ is independently a hydrolyzable group, a group having a hydrolyzable group, a hydroxyl group, or a hydrocarbon group,
at least four of R¹ are hydrolyzable groups, groups having a hydrolyzable group, or hydroxyl groups, and
n1 is an integer of 1 to 3.
   [2]

The compound according to Item [1], wherein n1 is 1.

[3]

The compound according to Item [1], wherein
the group P is —[Si(OR²)₂—O]ₙ₁—Si(OR²)₃,
where
each R² is independently a hydrocarbon group.
   [4]

The compound according to Item [2], wherein
the group P is —Si(OR²)₂—O—Si(OR²)₃,
where
each R² is independently a hydrocarbon group.
   [5]

A compound represented by Formula (1) or Formula (2) shown below,

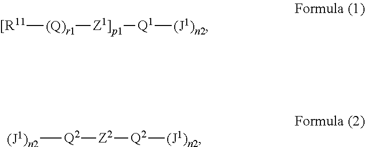

where
each J¹ is independently a group P shown below,

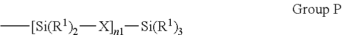

each X is independently an oxygen atom or a carbon atom,
each R¹ is independently a hydrolyzable group, a group having a hydrolyzable group, a hydroxyl group, or a hydrocarbon group,
at least four of the R¹ groups are hydrolyzable groups, groups having a hydrolyzable group, or hydroxyl groups, and
n1 is an integer of 1 to 3,
each R¹¹ is independently (R¹¹¹)₃Si—, a linear organopolysiloxane residue, a cyclic organopolysiloxane residue, or a cage-like organopolysiloxane residue,
each R¹¹¹ is independently a hydrocarbon group or a trialkylsilyloxy group,
each Q is independently —O— or —OC(═O)—,
each r1 is independently 0 or 1,
each Z¹ is independently a single bond, an alkylene group which may have an etheric oxygen atom, an organopolysiloxane group, or a combination of an alkylene group which may have an etheric oxygen atom and an organopolysiloxane group,
Z² is an organopolysiloxane group or a combination of an alkylene group which may have an etheric oxygen atom and an organopolysiloxane group,
Q¹ is a linking group having a valency of (p1+n2),
each Q² is independently a linking group having a valency of (1+n2),
p1 is an integer of 1 or greater, and
each n2 is independently an integer of 1 or greater.
   [6]

The compound according to Item [5], wherein n2 is an integer of 1 to 3.

[7]

The compound according to Item [5] or [6], wherein
Z¹ is —(Si(R⁸)₂—O)ₘ—Si(R⁸)₂—,
where
each R⁸ is independently a hydrocarbon group, and
m is a number of 1 or greater.
   [8]

The compound according to any one of Items [5] to [7], wherein
Z² is —(Si(R⁸)₂—O)ₘ—Si(R⁸)₂—,
where
each R⁸ is independently a hydrocarbon group, and
m is a number of 1 or greater.
   [9]

A composition comprising a compound according to any one of Items [1] to [8] and a liquid medium.

[10]

A surface treatment agent comprising a compound according to any one of Items [1] to [8].

[11]

A surface treatment agent comprising a compound according to any one of Items [1] to [8] and a liquid medium.

[12]

A method for manufacturing an article including a surface-treated layer formed on a substrate by performing a surface treatment on the substrate by using a surface treatment agent comprising a compound according to any one of Items [1] to [8].

[13]

An article comprising a substrate, and a surface-treated layer disposed on the substrate, a surface of the surface-treated layer being treated with a surface treatment agent comprising a compound according to any one of Items [1] to [8].

[14]

The article according to Item [13], wherein the article is an optical member.

[15]

The article according to Item [13], wherein the article is a display or a touch panel.

[16]

An intermediate represented by the following Formula (3):

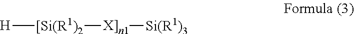

wherein
each X is independently an oxygen atom or a carbon atom,
each R¹ is independently a hydrolyzable group, a group having a hydrolyzable group, a hydroxyl group, or a hydrocarbon group,
at least four of the R¹ are hydrolyzable groups, groups having a hydrolyzable group, or hydroxyl groups, and
n1 is an integer from 1 to 3.
   [17]

The intermediate according to Item [16], wherein n1 is 1.

According to the present disclosure, it is possible to provide a new compound or the like capable of forming a surface-treated layer with excellent abrasion resistance.

The above and other objects, features and advantages of the present disclosure will become more fully understood from the detailed description given hereinbelow.

### DESCRIPTION OF EMBODIMENTS

A numerical value range specified by using “-” in the specification of the present disclosure includes numerical values before and after “-” as a lower limit value and an upper limit value, respectively, of the range.

In numerical ranges described in a stepwise manner in the present specification, the upper or lower limit value of one numerical range may be replaced with the upper or lower limit value of another numerical range described in a stepwise manner. Further, in numerical ranges described in a stepwise manner in the present specification, the upper or lower limit value of a numerical range may be replaced with values shown in Examples.

In the specification of the present disclosure, the “surface-treated layer” refers to a layer that is formed on the surface of a substrate by a surface treatment.

In this specification, “Me” may represent a methyl group, and “Et” may represent an ethyl group.

In this specification, when a compound or a group is represented by a specific formula (X), the compound or the group represented by this formula (X) may be expressed as a compound (X) or a compound X, and a group (X) or a group X, respectively.

Note that when the same symbols are present in one chemical formula, these same symbols may represent structures same as each other, or may represent structures different from each other within a specified range.

The bonding direction of a divalent group shown in the specification of the present disclosure is not limited to any particular directions unless otherwise specified. For example, when Y is —COO— in a compound represented by a formula “X—Y—Z”, Y may be —CO—O— or —O—CO—. Further, the aforementioned compound may be “X—CO—O—Z” or “X—O—CO—Z”.

### [Compound]

A compound according to the present disclosure comprises a below-shown group P and an organopolysiloxane residue.

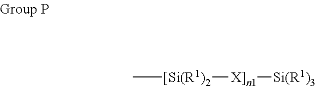

wherein: each X is independently an oxygen atom or a carbon atom; each R¹ is independently a hydrolyzable group, a group having a hydrolyzable group, a hydroxyl group, or a hydrocarbon group; at least four of R¹ are hydrolyzable groups, groups having a hydrolyzable group, or hydroxyl groups; and n1 is an integer of 1 to 3.

When the compound according to the present disclosure is used as a surface treatment agent, a surface-treated layer with excellent liquid repellency can be formed. Although the reason for this feature is not clear, it is presumed as follows.

The compound comprising the above-shown group P disclosed herein has a high adhesive property between the group P and a substrate, so that a surface-treated layer with excellent durability can be formed on the substrate. As a result, a surface-treated layer with excellent liquid repellency (water repellency and oil repellency) can be formed.

### <Group P>

The compound according to the present disclosure comprises the above-shown group P. Only one group P may be contained in the compound, or two or more groups P may be contained in the compound. For example, the number of groups P is preferably 1 to 18, more preferably 2 to 12, and still more preferably 2 to 8.

When a plurality of groups P are contained in one molecule, the plurality of groups P may be the same as each other or different from each other. The plurality of groups P are preferably the same as each other in view of the availability of raw materials and the ease of the manufacturing of the compound.

Each R¹ is independently a hydrolyzable group, a group having a hydrolyzable group, a hydroxyl group, or a hydrocarbon group.

The hydrolyzable group is a group which becomes a hydroxyl group through a hydrolysis reaction. That is, a hydrolyzable silyl group represented by Si—R¹ becomes a silanol group represented by Si—OH through a hydrolysis reaction. Such silanol groups further react with each other and thereby form a Si—O—Si bond. Further, such a silanol group has a dehydration condensation reaction with a silanol group derived from an oxide present on the surface of the substrate, and thereby can form a Si—O—Si bond.

Examples of hydrolyzable groups include an alkoxy group, an aryloxy group, a halogen atom, an acyl group, an acyloxy group, an isocyanato group (—NCO), and an alkylene oxide-modified alkoxy group.

The number of carbon atoms of the alkoxy group is preferably 1 to 6 and more preferably 1 to 4. The aryloxy group is preferably an aryloxy group having an aryl group containing a number of carbon atoms of 3 to 10. However, the aryl group of the aryloxy group may be a heteroaryl group. The halogen atom is preferably a chlorine atom. The acyl group is preferably an acyl group having a number of carbon atoms of 1 to 6. The acyloxy group is preferably an acyloxy group having a number of carbon atoms of 1 to 6.

The group having a hydrolyzable group may be, for example, the group having a hydrolyzable group shown above as an example. The group having a hydrolyzable group is preferably —O-L^{A}-L^{B}. L^{A} is an alkylene group, and L^{B} is a hydrolyzable group. The number of carbon atoms of the alkylene group is preferably 1 to 10. The hydrolyzable group represented by L^{B} is synonymous with the above-described hydrolyzable group represented by R¹, and its preferred forms are also the same as those described above. Specific examples of the group having a hydrolyzable group include —O—CH₂CH₂—OCH₃.

In particular, the hydrolyzable group or the group having a hydrolyzable group in R¹ is preferably an alkoxy group containing 1 to 4 carbon atoms, an alkylene oxide-modified alkoxy group, or a halogen atom from the viewpoint of ease of the manufacturing of the compound. R¹ is preferably an alkoxy group containing 1 to 4 carbon atoms, and more preferably an ethoxy group or a methoxy group in view of the fact that outgassing during the application process is small and because the storage stability of the compound becomes more excellent.

Examples of the hydrocarbon group in R¹ include an alkyl group, a cycloalkyl group, an alkenyl group, and an allyl group. Further, from the viewpoint of ease of the synthesis and the like, the hydrocarbon group in R¹ is preferably a saturated hydrocarbon group, and more preferably an alkyl group. The number of carbon atoms of the hydrocarbon group is preferably 1 to 6, more preferably 1 to 3, and still more preferably 1 to 2.

n1 is an integer of 1 to 3. Further, from the viewpoint of ease of the synthesis, n1 is preferably 1 to 2 and more preferably 1.

Among a plurality of R¹ contained in one group P, at least four of them are hydrolyzable groups, groups having a hydrolyzable group, or hydroxyl groups. In this way, the group P and the substrate are bonded to each other more firmly, so that a surface-treated layer with excellent durability is obtained. From the above-described features, the number of hydrolyzable groups, groups having a hydrolyzable group, and hydroxyl groups contained in the group P is preferably 4 to 9, more preferably 4 to 7, and still more preferably 4 or 5.

Note that the plurality of R¹ contained in one molecule may be the same as each other or different from each other. For example, the plurality of R¹ may be hydrolyzable groups identical to each other.

Each X is independently an oxygen atom or a carbon atom. Note that a carbon atom in X means that two Si are connected to each other through one carbon atom, and X may be —CH₂—, —C(CH₃)₂—, or the like. In view of the durability of the surface-treated layer, X is preferably an oxygen atom, —CH₂—, or —C(CH₃)₂—, more preferably an oxygen atom or —CH₂—, and still more preferably an oxygen atom.

The group P is preferably —[Si(OR²)₂—O]ₙ₁—Si(OR²)₃, and particularly preferably —Si(OR²)₂—O—Si(OR²)₃, i.e., n1=1, because the durability of the surface-treated layer becomes excellent. Note that each R² is independently a hydrocarbon group. Examples of hydrocarbon groups include an alkyl group, a cycloalkyl group, an alkenyl group, and an allyl group. Further, from the viewpoint of ease of the synthesis, the hydrocarbon group is preferably a saturated hydrocarbon group, and more preferably an alkyl group. The number of carbon atoms of R² is preferably 1 to 6, more preferably 1 to 3, and still more preferably 1 to 2.

Examples of the group P include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

### <Organopolysiloxane Residue>

Since the compound according to the present disclosure has an organopolysiloxane residue, it makes it possible to form a surface-treated layer with excellent liquid repellency. The organopolysiloxane residue refers to a group having a —Si—O-skeleton, and its specific examples include groups similar to those of R¹¹ described later.

### <Compound (1), Compound (2)>

The compound according to the present disclosure is a compound represented by Formula (1) or Formula (2) shown below.

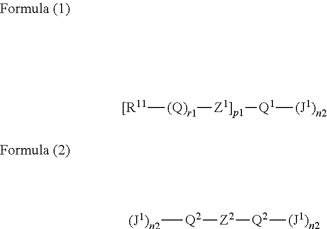

Note that each J¹ is independently the above-described group P, and repeated explanation is omitted.

Further, each R¹¹ is independently (R¹¹¹)₃Si—, a linear organopolysiloxane residue, a cyclic organopolysiloxane residue, or a cage-like organopolysiloxane residue; each R¹¹¹ is independently a hydrocarbon group or a trialkylsilyloxy group; each Q is independently —O— or —OC(═O)—; each r1 is independently 0 or 1; each Z¹ is independently a single bond, an alkylene group which may have an etheric oxygen atom, an organopolysiloxane group, or a combination of an alkylene group which may have an etheric oxygen atom and an organopolysiloxane group; Z² is an organopolysiloxane group or a combination of an alkylene group which may have an etheric oxygen atom and an organopolysiloxane group; Q¹ is a linking group having a valency of (p1+n2); Q² is a linking group having a valency of (1+n2); p¹ is an integer of 1 or greater; and n2 is an integer of 1 or greater.

Each R¹¹ is independently (R¹¹¹)₃Si—, a linear organopolysiloxane residue, a cyclic organopolysiloxane residue, or a cage-like organopolysiloxane residue, and each R¹¹¹ is independently a hydrocarbon group or a trialkylsilyloxy group.

Examples of the hydrocarbon group in R¹¹¹ include an alkyl group, a cycloalkyl group, and an aryl group. Further, the hydrocarbon group in R¹¹¹ is preferably a saturated hydrocarbon group, and more preferably an alkyl group from the viewpoint of ease of the synthesis and the like. The number of carbon atoms of R¹¹¹ is preferably 1 to 8, more preferably 1 to 4, and still more preferably 1 to 2.

The trialkylsilyloxy group in R¹¹¹ is preferably a group represented by R⁴⁰₃SiO—. Note that each R⁴⁰ is independently a hydrocarbon group. The hydrocarbon group in R⁴⁰ is preferably an alkyl group or an aryl group, and more preferably an alkyl group. The number of carbon atoms of R⁴⁰ is preferably 1 to 6, more preferably 1 to 4, and still more preferably 1 to 2.

The linear organopolysiloxane residue in R¹¹ is preferably a group (A2) shown below.

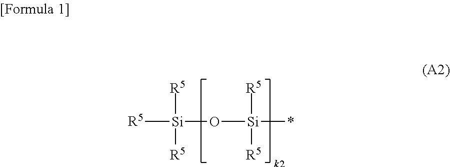

Note that each R⁵ is independently a hydrocarbon group, and k2 is a number of 1 or greater.

The hydrocarbon group in R⁵ is preferably an alkyl group or an aryl group, and more preferably an alkyl group. The number of carbon atoms of R⁵ is preferably 1 to 6, more preferably 1 to 4, and still more preferably 1 to 2. Specific examples of the hydrocarbon group in R⁵ include —CH₃, —CH₂CH₃, and —C(CH₃)₃.

k2 may be a number of 1 or greater, preferably 2 to 500, and more preferably 3 to 300.

The cyclic organopolysiloxane residue in R¹¹ is preferably the group (A3) shown below.

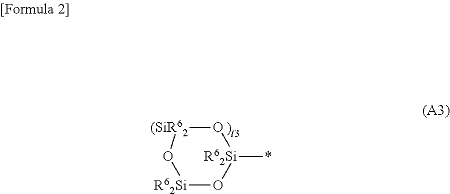

Note that each R⁶ is independently a hydrocarbon group, a hydrocarbon group having a substituent, or a trialkylsilyloxy group, and t3 is a number from 1 to 4.

The hydrocarbon group in R⁶ is preferably an alkyl group or an aryl group, and more preferably an alkyl group.

The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. The same applies to the alkyl group in the trialkylsilyloxy group.

Regarding the hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Specific examples of cyclic organopolysiloxane residues include groups shown below.

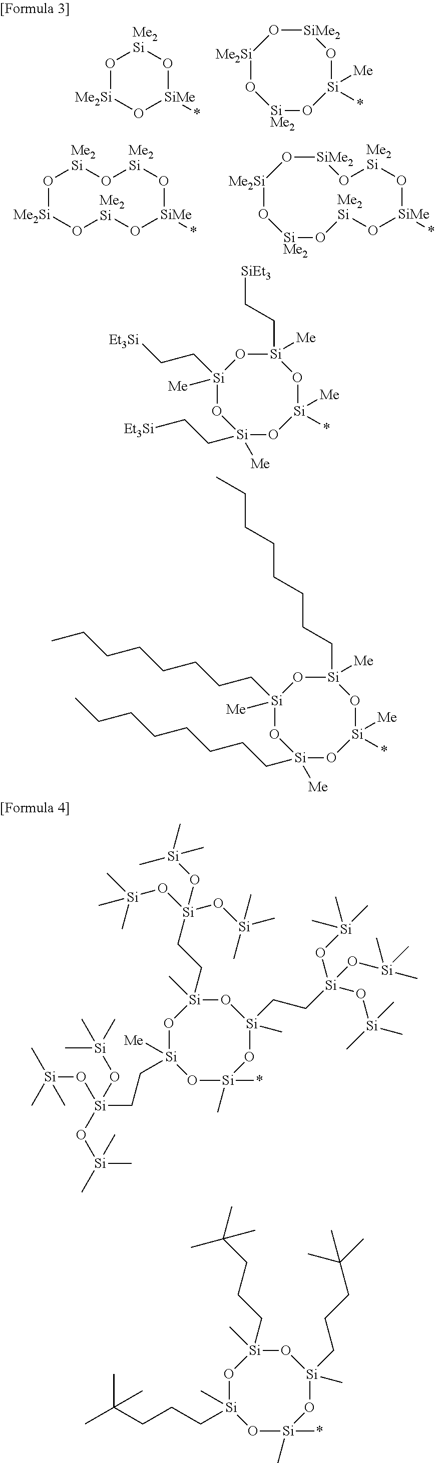

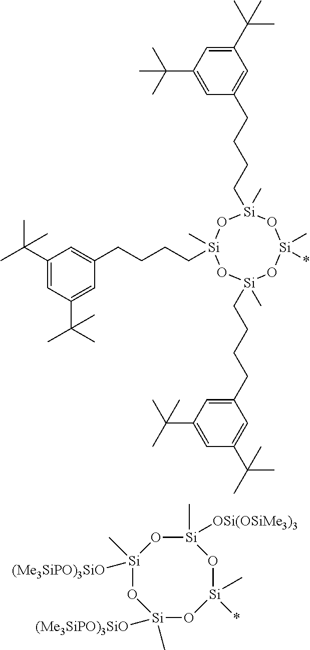

The cage-like organopolysiloxane residue in R¹¹ is preferably a group (A4) shown below.

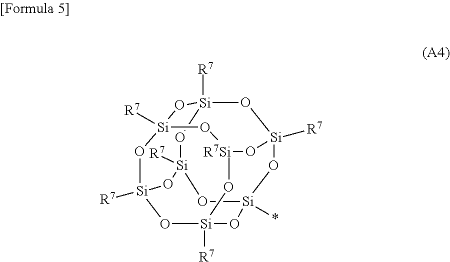

Note that each R⁷ is independently a hydrocarbon group, a hydrocarbon group having a substituent, or a trialkylsilyloxy group.

The hydrocarbon group in R⁷ is preferably an alkyl group or an aryl group, and more preferably an alkyl group.

The alkyl group may be any of a linear alkyl group, a branched alkyl group, or a cyclic alkyl group, and is preferably a linear alkyl group. The number of carbon atoms of the alkyl group is preferably 1 to 10, more preferably 1 to 8, and still more preferably 1 to 4. The same applies to the alkyl group in the trialkylsilyloxy group.

Regarding the hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Specific examples of cage-like organopolysiloxane residues include groups shown below.

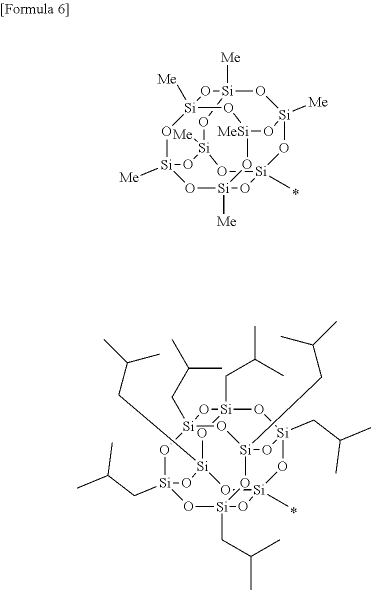

Each Q is independently —O— or —OC(═O)— and r1 is 0 or 1. Therefore, when r1 is 0, it is a single bond.

Each Z¹ is independently a single bond, an alkylene group which may have an etheric oxygen atom, an organopolysiloxane group, or a combination of an alkylene group which may have an etheric oxygen atom and an organopolysiloxane group.

Z² is an organopolysiloxane group or a combination of an alkylene group which may have an etheric oxygen atom and an organopolysiloxane group. As a representative example, Z¹ will be described hereinafter.

In the following description of Z¹, it is understood that Z² is limited to an organopolysiloxane group or a combination of an alkylene group which may have an etheric oxygen atom and an organopolysiloxane group.

The number of carbon atoms of the alkylene group which may have an etheric oxygen atom may be 1 or greater, and in view of the water repellency, is preferably 2 or greater and more preferably 4 or greater. The upper limit value of the number of carbon atoms of the alkylene group is not limited to any particular values, but may be 30 or less, and is preferably 24 or less. The alkylene group which may have an etheric oxygen atom in the compound according to the present disclosure may be any of linear, branched, and cyclic, but is preferably linear or branched, and more preferably linear.

The organopolysiloxane group is preferably a group (A6) shown below.

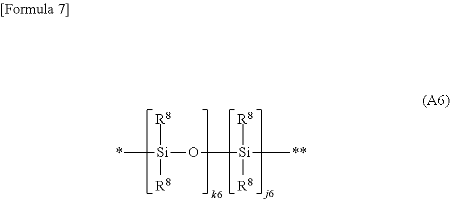

Note that each R⁸ is independently a hydrocarbon group; k6 is a number of 1 or greater; j6 is 0 or 1; * is a bond on the Q side; and ** is a bond on the Q¹ side. Note that in the case of Z², * is a bond on one of Q² sides, and ** is a bond on the other Q² side.

Examples of the hydrocarbon group in R⁸ include an alkyl group, a cycloalkyl group, an alkenyl group, and an allyl group. Further, from the viewpoint of ease of the synthesis and the like, the hydrocarbon group in R⁸ is preferably a saturated hydrocarbon group, and more preferably an alkyl group. The number of carbon atoms of R⁸ is preferably 1 to 6, more preferably 1 to 3, and particularly preferably 1 to 2.

k6 may be a number of 1 or greater, and is preferably a number of 2 to 500, and more preferably a number of 3 to 300.

Each of Z¹ and Z² is preferably —(Si(R⁸)₂—O)ₘ—Si(R⁸)₂— in view of the durability of the surface-treated layer. Note that m is synonymous with the above-described k6, and each R⁸ is independently a hydrocarbon group and is synonymous with the above-described definition.

Examples of combinations of an alkylene group which may have an etheric oxygen atom and an organopolysiloxane group include groups (B1) to (B4) shown below.

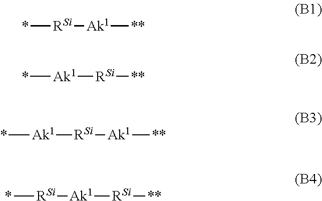

Note that each Ak¹ is independently an alkylene group; each R^{Si} is independently the above-shown group (A6); * is a bond on the Q side; and ** is a bond on the Q¹ side. Note that in the case of Z², * is a bond on one of Q² sides, and ** is a bond on the other Q² side.

The number of carbon atoms of the alkylene group in Ak¹ may be 1 or greater, and in view of the water repellency, is preferably 2 or greater and more preferably 4 or greater. The upper limit value of the number of carbon atoms of the alkylene group is not limited to any particular values, but may be 30 or less, and is preferably 24 or less. The alkylene group in Ak¹ is preferably linear or branched, and more preferably linear.

The combination of an alkylene group and an organopolysiloxane group, or the combination of an alkylene group and an organopolysiloxane group is preferably the group (B1), the group (B3), or the group (B4), more preferably the group (B1) or the group (B4) in view of the water repellency, and still more preferably the group (B1) from the viewpoint of ease of the manufacturing.

Q¹ is a linking group having a valency of (p1+n2), and Q² is a linking group having a valency of (1+n2). As a representative example, Q¹ will be described hereinafter. In the following description of Q¹, it is understood that Q² is limited to those in which p1 is limited to 1.

It is sufficient if Q¹ is a group which does not impair the effects of the present disclosure, and its examples include an alkylene group which may have an etheric oxygen atom or a divalent organopolysiloxane group, a carbon atom, a nitrogen atom, a silicon atom, organopolysiloxane groups having a valency of 2 to 8, and groups obtained by excluding J¹ (i.e., the group P) from groups (3-1A), (3-1B), and (3-1A-1) to (3-1A-7) (which will be described later).

However, in the case where the end of Z¹ on the side which is bonded to Q¹ is an alkylene group, it is assumed that the end of Q¹ on the side which is bonded to Z is not an alkylene group. Further, in the case where Z¹ is an organopolysiloxane group, it is assumed that the end of Q¹ on the side which is bonded to Z¹ is not an organopolysiloxane group.

Further, Q¹ may be any of groups (g2-1) to (g2-14) described later.

p1 is an integer of 1 or greater. p1 is preferably 1 to 6 and more preferably 1 to 4 because the water repellency of the surface-treated layer becomes more excellent.

n2 is an integer of 1 or greater. n2 is preferably 1 to 15, more preferably 1 to 6, still more preferably 2 to 4, and particularly preferably 2 or 3 because the abrasion resistance of the surface-treated layer becomes more excellent.

The group represented by -Q¹-(J¹)ₙ₂ in Formula (1) is preferably a group (3-1A) or (3-1B) shown below, and more preferably the group (3-1A).

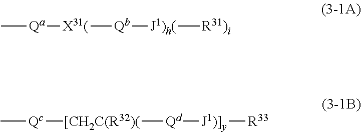

Q^{a} is a single bond or a divalent linking group.

However, when the end of Z¹ on the side which is bonded to Q¹ is an alkylene group, the end of Q^{a} on the side which is bonded to Z is not an alkylene group. Further, when Q¹ is an organopolysiloxane group, the end of Q^{a} on the side which is bonded to Z is not an organopolysiloxane group.

Examples of divalent linking groups include a divalent hydrocarbon group, a divalent heterocyclic group, —O—, —S—, —SO₂—, —N(R^{d})—, —C(O)—, —Si(R^{a})₂—, and groups in which two or more of these groups are combined.

The aforementioned divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and its examples include an alkylene group. The number of carbon atoms of the alkylene group is preferably 1 to 30, more preferably 1 to 20, still more preferably 4 to 20, and particularly preferably 5 to 15. Further, the divalent aromatic hydrocarbon group is preferably one containing 5 to 20 carbon atoms, and its examples include a phenylene group. Alternatively, the divalent aromatic hydrocarbon group may be an alkenylene group containing 2 to 20 carbon atoms or an alkynylene group containing 2 to 20 carbon atoms. The aforementioned R^{a} is an alkyl group (preferably one containing 1 to 10 carbon atoms) or a phenyl group.

The aforementioned R^{d} is a hydrogen atom or an alkyl group (preferably one containing 1 to 10 carbon atoms).

Note that examples of groups in which two or more of the aforementioned groups are combined are —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d}), an alkylene group having —N(R^{d})C(O)N(R^{d})—, an alkylene group having —SO₂N(R^{d})—, and an alkylene group-Si(R^{a})₂-phenylene group-Si(R^{a})₂.

In particular, when the end of Z¹ on the side which is bonded to Q¹ is an alkylene group, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—; more preferably, —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—; and still more preferably, an alkylene group having —C(O)O— or an alkylene group having —C(O)N(R^{d})—.

When Z¹ is an organopolysiloxane group, Q¹ is preferably a divalent hydrocarbon group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, an alkylene group having —SO₂N(R^{d})—, or an alkylene group-Si(R^{a})₂— phenylene group-Si(R^{a})₂, and more preferably —C(O)—.

In Formula (3-1A), X³¹ is a single bond, an alkylene group, a carbon atom, a nitrogen atom, a silicon atom, an organopolysiloxane group having a valency of 2 to 8, or a group having a ring having a valency of (h+i+1).

However, when the end of Z¹ on the side which is bonded to Q¹ is an alkylene group and Q^{a} is a single bond, the end of X³¹ on the side which is bonded to Z¹ is not an alkylene group.

Further, when Z¹ is an organopolysiloxane group and Q¹ is a single bond, the end of X³¹ on the side which is bonded to Z is not an organopolysiloxane group. In the other cases, the end of X³¹ may be an alkylene group or an organopolysiloxane group.

Note that the aforementioned alkylene group may have —O—, a silphenylene skeleton group, a divalent organopolysiloxane group, or a dialkylsilylene group. The alkylene group may have a plurality of groups selected from the group consisting of —O—, a silphenylene skeleton group, a divalent organopolysiloxane group, and a dialkylsilylene group.

The number of carbon atoms of the alkylene group represented by X³¹ is preferably 1 to 20 and more preferably 1 to 10.

Examples of the organopolysiloxane group having a valency of 2 to 8 include a divalent organopolysiloxane group and an organopolysiloxane group having a valency of (w+1) described later.

In Formula (3-1A), when X³¹ is a group having a ring having a valency of (h+i+1), Q^{a} (-Q^{b}-J¹), and R³¹ are directly bonded to atoms constituting the ring. However, this ring is a ring other than the organopolysiloxane ring.

The ring in X³¹ may be any of a monocyclic ring, a condensed polycyclic ring, a bridged ring, a spiro ring, and an assembled polycyclic ring, and the atoms constituting the ring may be a carbon ring consisting solely of carbon atoms or a heterocyclic ring consisting of heteroatoms having a valency of 2 or greater and carbon atoms. Further, the bond between the atoms constituting the ring may be a single bond or multiple bonds. Further, the ring may be an aromatic ring or a non-aromatic ring.

The monocyclic ring is preferably a 4 to 8 membered ring, and more preferably a 5 membered ring or a 6 membered ring. The condensed polycyclic ring is preferably a condensed polycyclic ring in which two or more 4 to 8 membered rings are condensed, more preferably a condensed polycyclic ring in which two or three rings each selected from a 5 membered ring and a 6 membered ring are bonded, and still more preferably a condensed polycyclic ring in which one or two rings each selected from a 5 membered ring and a 6 membered ring and one 4 membered ring are bonded. The bridged ring is preferably a bridged ring in which a 5 membered ring or a 6 membered ring is the largest ring, and the spiro ring is preferably a spiro ring consisting of two 4 to 6 membered rings. The assembled polycyclic ring is preferably an assembled polycyclic ring in which two or three rings each selected from a 5 membered ring and a 6 membered ring are bonded through a single bond, through one to three carbon atoms, or through one heteroatom having a valency of two or three. Note that in the assembled polycyclic ring, one of Q^{a}, (-Q^{b}-J¹) and R³¹ (when i=1 or greater) is preferably bonded to each ring.

The heteroatoms constituting the aforementioned ring are preferably nitrogen atoms, oxygen atoms, and sulfur atoms, and more preferably nitrogen atoms and oxygen atoms. The number of heteroatoms constituting the ring is preferably three or less. Further, when the number of heteroatoms constituting the ring is two or greater, these heteroatoms may be different from one another.

The ring in X⁻ is preferably one selected from the group consisting of a 3 to 8 membered aliphatic ring, a benzene ring, a 3 to 8 membered heterocyclic ring, a condensed ring in which two or three of these rings are condensed, a bridged ring in which a 5 membered ring or a 6 membered ring is the largest ring, and an assembled polycyclic ring having two or more of these rings, in which the linking group is a single bond, an alkylene group having a number of carbon atoms of 3 or less, an oxygen atom, or a sulfur atom, from the viewpoint of ease of the manufacturing of the compound and because the abrasion resistance of the surface-treated layer becomes more excellent.

Preferred rings are a benzene ring, a 5 or 6 membered aliphatic ring, a 5 or 6 membered heterocyclic ring having a nitrogen atom or an oxygen atom, and a condensed ring consisting of a 5 or 6 membered carbon ring and a 4 to 6 membered heterocyclic ring.

Specific examples of rings include the below-shown rings, a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Note that rings having an oxo group (═O) are also shown below.

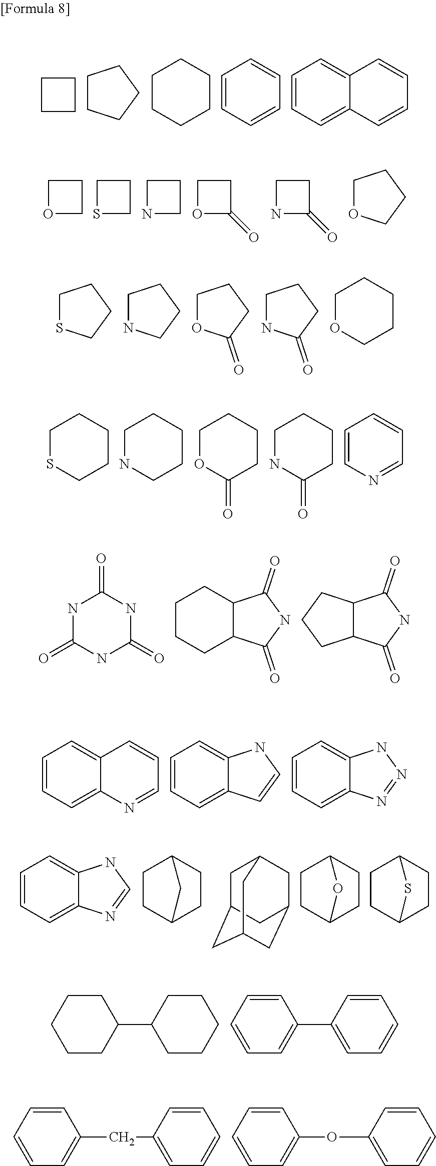

The bond that does not constitute the ring of atoms constituting the ring in X³¹ is a bond that is bonded to Q^{a}, (Q^{b}-J¹) or R³¹. When there is a remaining bond(s), the remaining bond(s) is bonded to a hydrogen atom or a substituent. Examples of such substituents include a halogen atom, an alkyl group (which may comprise an etheric oxygen atom between carbon atoms), a cycloalkyl group, an alkenyl group, an allyl group, an alkoxy group, and an oxo group (═O).

Further, when one of the carbon atoms constituting the ring has two bonds that are bonded to Q^{a}, (-Q^{b}-J¹), or R³¹, Q^{a} and (-Q^{b}-J¹) may be bonded to this one carbon atom, or two ((-Q^{b}-J¹)) may be bonded to this one carbon atom. Q^{a} and (-Q^{b}-J¹) or R¹¹ are preferably bonded to ring constituent atoms different from each other. Each of h (-Q^{b}-J¹) (i.e., h pieces of (-Q^{b}-J¹)) may be bonded to ring constituent atoms different from each other, or two of them may be bonded to one of the ring constituent carbon atoms. Alternatively, there may be two or more ring constituent carbon atoms to which two ((-Q^{b}-J¹)) are bonded. i R³¹ (i.e., i pieces of R³¹) may be bonded to ring constituent atoms different from each other, or two of them may be bonded to one ring constituent carbon atom. Alternatively, there may be two or more ring constituent carbon atoms to which two R³¹ are bonded.

In particular, in order to improve the abrasion resistance of the surface-treated layer, X³¹ is preferably a carbon atom, a nitrogen atom, a silicon atom, an organopolysiloxane group having a valency of 4 to 8, or a group having a ring having a valency of (h+i+1), and more preferably a carbon atom.

In Formula (3-1A), Q^{b} is a single bond or a divalent linking group. The definition of the divalent linking group is synonymous with the definition described above for Q^{a}.

However, when the end of Z¹ on the side which is bonded to Q¹ is an alkylene group, and Q^{a} and X³¹ are single bonds, the end of Q^{b} on the side which is bonded to Z¹ is not an alkylene group. Further, when Z¹ is an organopolysiloxane group, and Q^{a} and X³ are single bonds, the end of Q^{b} on the side which is bonded to Z is not an organopolysiloxane group. In the other cases, the end of Q^{b} may be an alkylene group or an organopolysiloxane group.

In particular, Q^{b} is preferably an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the number of carbon atoms may be 1 to 10.

In Formula (3-1A), R³¹ is a hydrogen atom, a hydroxyl group, or an alkyl group. The number of carbon atoms of the alkyl group is preferably 1 to 5, more preferably 1 to 3, and still more preferably 1.

When X³¹ is a single bond or an alkylene group, h is 1 and i is 0,
when X³¹ is a nitrogen atom, h is an integer of 1 or 2 and i is an integer of 0 or 1, where h+i=2,
when X³¹ is a carbon atom or a silicon atom, h is an integer of 1 to 3 and i is an integer of 0 to 2, where h+i=3, and
when X³¹ is an organopolysiloxane group having a valency of 2 to 8, h is an integer of 1 to 7 and i is an integer of 0 to 6, where h+i=1 to 7.

When X³¹ is a group having a ring having a valency of (h+i+1), h is an integer of 1 to 7 and i is an integer of 0 to 6, where h+i=1 to 7.

When there are two or more (-Q^{b}-J¹), the two or more (-Q^{b}-J¹) may be the same as each other or different from each other.

When there are two or more R³¹, the two or more (—R³¹) may be the same as each other or different from each other.

In particular, i is preferably 0 in order to improve the abrasion resistance of the surface-treated layer.

In Formula (3-1A), when Q^{a}, X³¹, and Q^{b} are single bonds, J¹ is directly bonded to Z¹ and Z¹ is an alkylene group.

In Formula (3-1B), Q^{e} is a single bond or a divalent linking group.

However, when the end of Z¹ on the side which is bonded to Q¹ is an alkylene group, the end of Q^{e} on the side which is bonded to Z¹ is not an alkylene group. When Z¹ is an organopolysiloxane group, the end of Q^{e} on the side which is bonded to Z¹ is not an organopolysiloxane group.

The definition of the divalent linking group is synonymous with the definition described above for Q^{a}.

In Formula (3-1B), R³² is a hydrogen atom or an alkyl group having a number of carbon atoms of 1 to 10, and is preferably a hydrogen atom from the viewpoint of ease of the manufacturing of the compound.

The alkyl group is preferably a methyl group.

In Formula (3-1B), Q^{d} is a single bond or an alkylene group. The number of carbon atoms of the alkylene group is preferably 1 to 10 and more preferably 1 to 6. In view of the ease of the manufacturing of the compound, Q^{d} is preferably a single bond or CH₂—.

In Formula (3-1B), R³³ is a hydrogen atom or a halogen atom, and is preferably a hydrogen atom from the viewpoint of ease of the manufacturing of the compound.

y is an integer of 1 to 10, and preferably an integer of 1 to 6.

The two or more [CH₂C(R³²)(-Q^{d}-J¹)] may be the same as each other or different from each other.

The group (3-1A) is preferably one of groups (3-1A-1) to (3-1A-7) shown below.

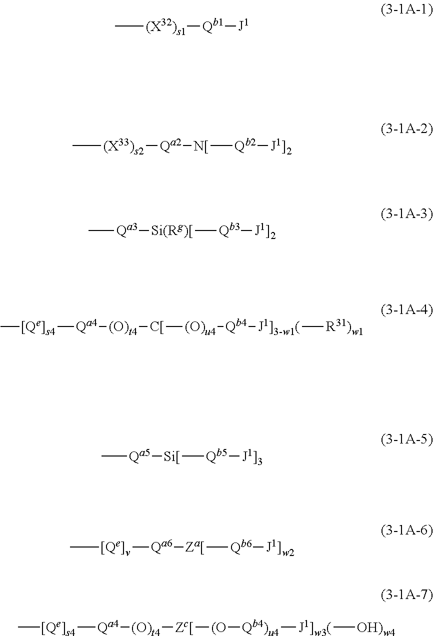

However, when the end of Z¹ on the side which is bonded to Q¹ is an alkylene group, the ends of the groups (3-1A-1) to (3-1A-7) on the sides which are bonded to Z¹ are not alkylene groups. Further, when Z¹ is an organopolysiloxane group, the ends of the groups (3-1A-1) to (3-1A-7) on the sides which are bonded to Z¹ are not organopolysiloxane groups.

In particular, the group (3-1A) is preferably the group (3-1A-4).

In the group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— (note that N in the formula is bonded to Q^{b1}).

The definition of R^{d} is the same as that described above.

s1 is 0 or 1.

In particular, when the end of Z¹ on the side which is bonded to Q¹ is an alkylene group, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; more preferably —O—, —S—, —N(R^{d})—, —C(O)O—, —C(O)S—, —N(R^{d})C(O)N(R^{d})—, —OC(O)N(R^{d})—, or —C(O)N(R^{d})—; and more preferably —C(O)O— or —C(O)N(R^{d})—.

When Z¹ is an organopolysiloxane group, X³² is preferably —C(O)O—, —C(O)S—, —SO₂N(R^{d})—, or —C(O)N(R^{d})—, and more preferably —C(O)—, and more preferably —C(O)—.

Q^{b1} is a single bond or an alkylene group. Note that the alkylene group may have —O—, a silphenylene skeleton group, or a dialkylsilylene group. The alkylene group may have a plurality of groups selected from the group consisting of —O—, a silphenylene skeleton group, a divalent organopolysiloxane group, and a dialkylsilylene group.

Note that when the alkylene group has —O—, a silphenylene skeleton group, a divalent organopolysiloxane group, or a dialkylsilylene group, it preferably has these groups between carbon atoms.

The number of carbon atoms of the alkylene group represented by Q^{b1} is preferably 1 to 30, more preferably 1 to 20, still more preferably 2 to 20, and particularly preferably 2 to 6. Further, the number of carbon atoms may be 1 to 10.

In particular, when the end of Z¹ on the side which is bonded to Q¹ is an alkylene group, s1 is preferably 1, and Q^{b1} is preferably an alkylene group containing 2 to 6 carbon atoms.

When Z¹ is an organopolysiloxane group, s1 is preferably 0, and Q^{b1} is preferably an alkylene group containing 2 to 6 carbon atoms.

In the case where the end of Z¹ on the side which is bonded to A¹¹ is an alkylene group, specific examples of the group (3-1A-1) include groups shown below. In the below-shown formula, * indicates a position of a bond with Z¹.

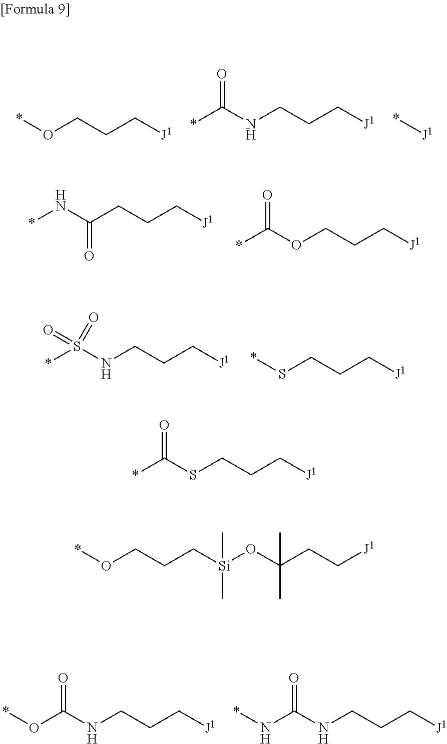

In the case where Z¹ is an organopolysiloxane group, specific examples of the group (3-1A-1) include groups shown below. In the below-shown formula, * indicates a position of a bond with Z¹.

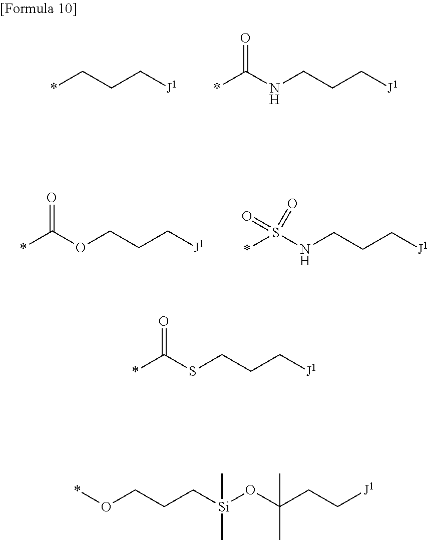

In the group (3-1A-2). X³¹ is —O—, —S—, —N(R^{d})—, —C(O)—, —C(O)O—, —C(O)S—, —SO₂N(R^{d})—, —N(R^{d})SO₂—, —N(R^{d})C(O)—, —N(R¹)C(O)N(R^{d})—, —OC(O)N(R^{d})—, or —C(O)N(R^{d})—.

The definition of R^{d} is the same as that described above.

s2 is 0 or 1. s2 is preferably 0 from the viewpoint of ease of the manufacturing of the compound.

In particular, when the end of Z¹ on the side which is bonded to Qt is an alkylene group, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.
When Z¹ is an organiopolysiloxane group, X³³ is preferably —C(O)O—, —C(O)S—, —SO₂N(R^{d})—, or —C(O)N(R^{d})—.

Q^{a2} is a single bond, an alkylene group, —C(O)—, or a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R¹)C(O)O—, —OC(O)N(R^{d})—, —SO₂N(R^{d})—, —N(R^{d})SO₂—, —C(O)N(R^{d})—, or —NH— between carbon atoms of an alkylene group containing two or more carbon atoms.

The number of carbon atoms of the alkylene group represented by Q^{a2} is preferably 1 to 20, more preferably 1 to 10, still more preferably 1 to 6, and particularly preferably 1 to 3.

The number of carbon atoms of the group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms of an alkylene group containing two or more carbon atoms and represented by Q^{a2}, is preferably 2 to 10 and more preferably 2 to 6.

Q^{a2} is preferably a single bond from the viewpoint of ease of the manufacturing of the compound.

Q^{b2} is an alkylene group, or a group having a divalent organopolysiloxane group, an etheric oxygen atom, or —NH— between carbon atoms of an alkylene group containing two or more carbon atoms.

The number of carbon atoms of the alkylene group represented by Q^{b2} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having a divalent organopolysiloxane group, an etheric oxygen atom, or —NH— between carbon atoms of an alkylene group containing two or more carbon atoms and represented by Q^{b2} is preferably 2 to 10 and more preferably 2 to 6.

Q^{b2} is preferably —CH₂CH₂CH₂— or —CH₂CH₂OCH₂CH₂CH₂— (note that the right side is bonded to Si) from the viewpoint of ease of the manufacturing of the compound.

The two [-Q^{b2}-J¹] may be the same as each other or different from each other.

In the case where the end of Z¹ on the side which is bonded to Q¹ is an alkylene group, specific examples of the group (3-1A-2) include groups shown below. In the below-shown formula, * indicates a position of a bond with Z. Further, in the formula, α in (CH₂)_{α}0 which is bonded to J¹ is an integer representing the number of methylene groups, and is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10. A plurality of a contained in the same compound may be the same as each other or different from each other, and is preferably the same as each other. For example, a plurality of a contained in the same compound are all 2, 3, 8, 9 or 11, and the same applies hereinafter.

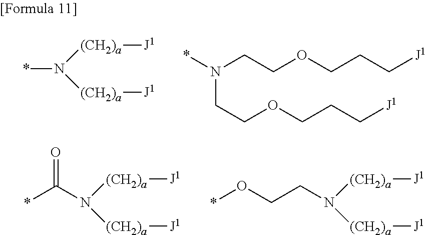

In the case where Z¹ is an organopolysiloxane group, specific examples of the group (3-1A-2) include groups shown below. In the below-shown formula, * indicates a position of a bond with Z¹.

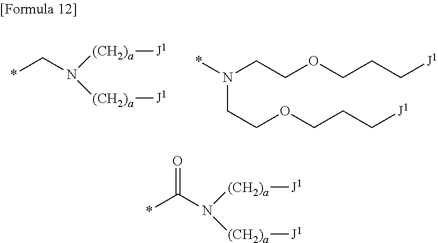

In the group (3-1A-3), Q^{a3} is a single bond, or an alkylene group which may have an etheric oxygen atom. In view of the ease of the manufacturing of the compound, Q^{a3} is preferably a single bond.

The number of carbon atoms of the alkylene group which may have an etheric oxygen atom is preferably 1 to 10 and particularly preferably 2 to 6.

R^{g} is a hydrogen atom, a hydroxyl group, or an alkyl group.

In view of the ease of the manufacturing of the compound, R^{g} is preferably a hydrogen atom or an alkyl group. The alkyl group preferably has 1 to 10 carbon atoms, more preferably 1 to 4 carbon atoms, and still more preferably is a methyl group.

Q^{b3} is an alkylene group, or a group having an etheric oxygen atom or a divalent organopolysiloxane group between carbon atoms of an alkylene group containing two or more carbon atoms.

The number of carbon atoms of the alkylene group represented by Q^{b3} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having an etheric oxygen atom or a divalent organopolysiloxane group between carbon atoms of an alkylene group containing two or more carbon atoms and represented by Q^{b3} is preferably 2 to 20, more preferably 2 to 10, and still more preferably 2 to 6.

Q^{b3} is preferably —CH₂CH₂—, —CH₂CH₂CH₂—, or —CH₂CH₂CH₂CH₂CH₂CH₂CH₂CH₂— from the viewpoint of ease of the manufacturing of the compound.

The two [-Q^{b3}=J¹] may be the same as each other or different from each other.

In the case where the end of Z¹ on the side which is bonded to Q¹ is an alkylene group, specific examples of the group (3-1A-3) include groups shown below. In the below-shown formula, * indicates a position of a bond with Z.

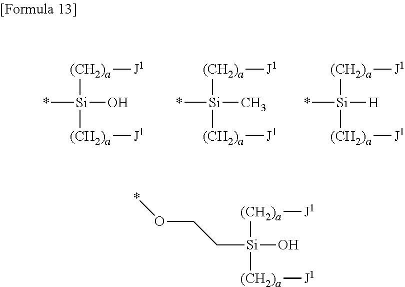

In the case where Z¹ is an organopolysiloxane group, specific examples of the group (3-1A-3) include groups shown below. In the below-shown formula, * indicates a position of a bond with Z¹.

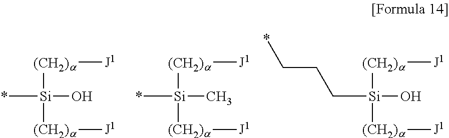

In the group (3-1A-4), Q^{e} is —C(O)O—, —SO₂N(R^{d})—, —N(R^{d})SO₂—, —N(R^{d})C(O)—, or —C(O)N(R^{d})—.

The definition of R³¹ is the same as that described above. When w1 is 1 or 2, R³¹ is preferably a hydrogen atom.

s4 is 0 or 1.

Q^{a4} is a single bond, or an alkylene group which may have an etheric oxygen atom.

The number of carbon atoms of the alkylene group which may have an etheric oxygen atom is preferably 1 to 20, more preferably 1 to 10, still more preferably 1 to 6, and particularly preferably 1 to 3.

t4 is 0 or 1 (note that it is 0 when Q^{a4} is a single bond).

In view of the ease of the manufacturing of the compound, when s4 is 0, -Q^{a4}-(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— (note that the left side is bonded to (XO)ₘ). Further, when s4 is 1, —Q^{a4}-(O)ₜ₄— is preferably a single bond, —CH₂—, or —CH₂CH₂—.

Q^{b4} is an alkylene group, and the aforementioned alkylene group may have —O—, —C(O)N(R^{d})— (the definition of R^{d} is the same as that described above), a silphenylene skeleton group, a divalent organopolysiloxane group, or a dialkylsilylene group.

Note that when the alkylene group has —O— or a silphenylene skeleton group, it preferably has —O— or a silphenylene skeleton group between carbon atoms. Further, when the alkylene group has a —C(O)N(R^{d})—, a dialkylsilylene group, or a divalent organopolysiloxane group, it preferably has these groups between carbon atoms or at the end on the side which is bonded to (O)ᵤ₄.

The number of carbon atoms of the alkylene group represented by Q^{b4} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

u4 is 0 or 1.

In view of the ease of the manufacturing of the compound, —(O)ᵤ₄-Q^{b4}- is preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂— (note that the right side is bonded to Si).

w1 is an integer of 0 to 2, preferably 0 or 1, and particularly preferably 0.

When there are two or more [—(O)ᵤ₄Q^{b4-}-J¹], two or more [—(O)ᵤ₄-Q^{b4}-J¹] may be the same as each other or different from each other.

When there are two or more R³¹, the two or more (—R³¹) may be the same as each other or different from each other.

In the case where the end of Z¹ on the side which is bonded to Q¹ is an alkylene group, specific examples of the group (3-1A-4) include groups shown below. In the below-shown formula, * indicates a position of a bond with Z¹.

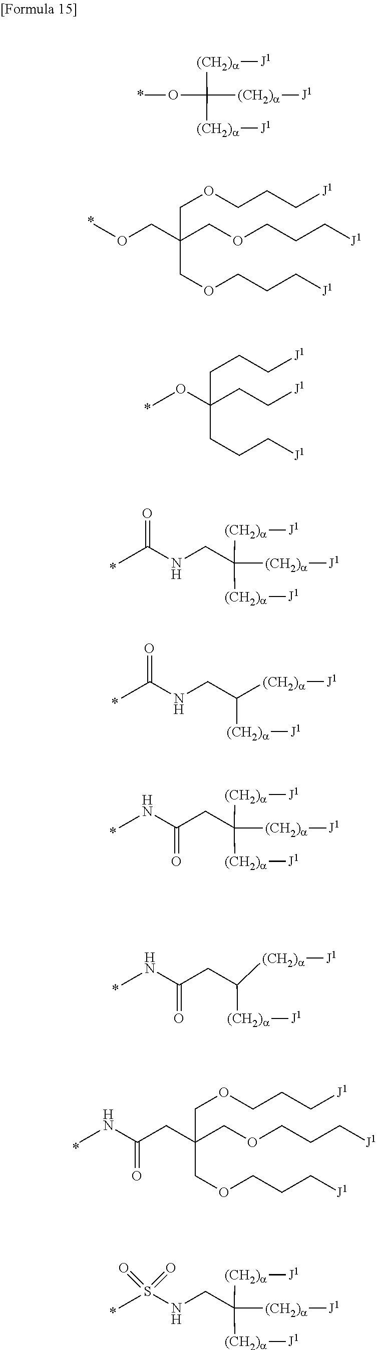

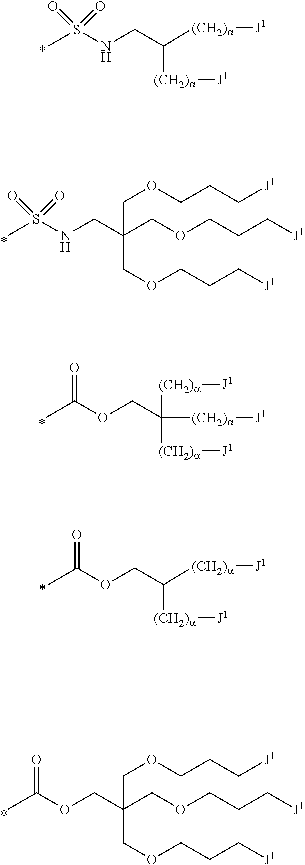

In the case where Z¹ is an organopolysiloxane group, specific examples of the group (3-1A-4) include groups shown below. In the below-shown formula, * indicates a position of a bond with Z¹.

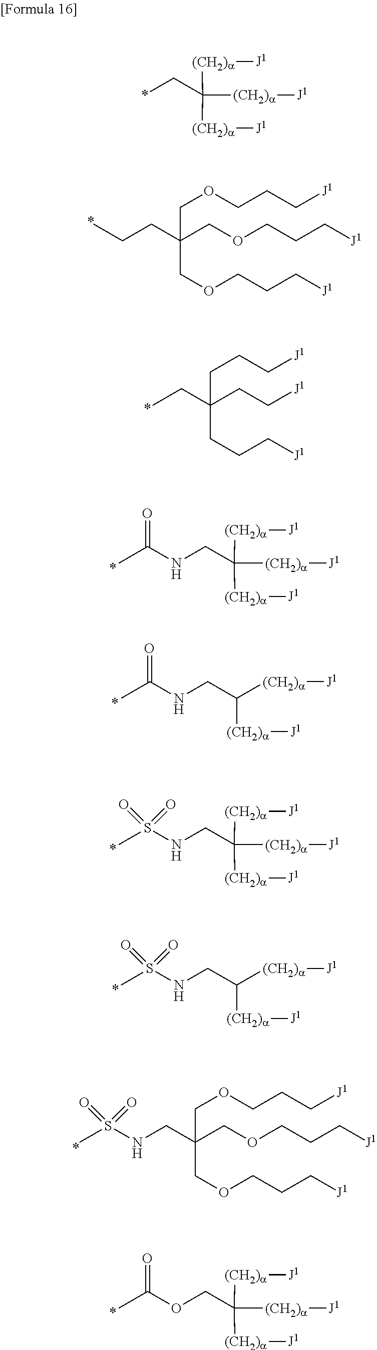

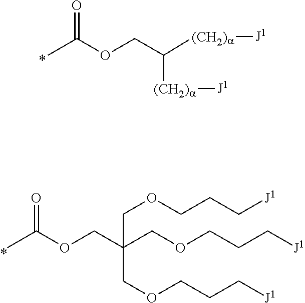

In the group (3-1A-5), Q^{a5} is an alkylene group which may have an etheric oxygen atom.

The number of carbon atoms of the alkylene group which may have an etheric oxygen atom is preferably 1 to 10 and particularly preferably 2 to 6.

In view of the ease of the manufacturing of the compound, Q^{a5} is preferably —OCH₂CH₂CH₂—, —OCH₂CH₂OCH₂CH₂CH₂—, —CH₂CH₂—, or CH₂CH₂CH₂— (note that the right side is bonded to Si).

Q^{b5} is an alkylene group, or a group having an etheric oxygen atom or a divalent organopolysiloxane group between carbon atoms of an alkylene group containing two or more carbon atoms.

The number of carbon atoms of the alkylene group represented by Q^{b5} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having an etheric oxygen atom or a divalent organopolysiloxane group between carbon atoms of an alkylene group containing two or more carbon atoms and represented by Q^{b5} is preferably 2 to 20, more preferably 2 to 10, and still more preferably 2 to 6.

Q^{b5} is preferably —CH₂CH₂CH₂— or —CH₂CH₂OCH₂CH₂CH₂— (note that the right side is bonded to J¹) from the viewpoint of ease of the manufacturing of the compound.

The three [-Q^{b5}-J¹] may be the same as each other or different from each other.

In the case where the end of Z¹ on the side which is bonded to Q¹ is an alkylene group, specific examples of the group (3-1A-5) include groups shown below. In the below-shown formula, * indicates a position of a bond with Z¹.

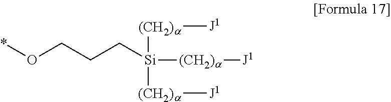

In the case where Z¹ is an organopolysiloxane group, specific examples of the group (3-1A-5) include groups shown below. In the below-shown formula, * indicates a position of a bond with Z¹.

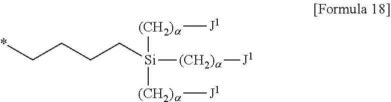

The definition of Q^{e} in the group (3-1A-6) is the same as that defined in the above-described group (3-1A-4).

v is 0 or 1.

Q^{a6} is an alkylene group which may have an etheric oxygen atom.

The number of carbon atoms of the alkylene group which may have an etheric oxygen atom is preferably 1 to 10 and particularly preferably 2 to 6.

In view of the ease of the manufacturing of the compound, Q^{a6} is preferably —CH₂OCH₂CH₂CH₂—, —CH₂OCH₂CH₂OCH₂CH₂CH₂—, —CH₂CH₂—, or —CH₂CH₂CH₂— (note that the right side is bonded to Z^{a}.).

Z^{a} is an organopolysiloxane group having a valency of (w2+1), or a group having a valency of (w2+1) and having an alkylene group between organopolysiloxane groups.

w2 is an integer of 2 to 7.

Examples of the organopolysiloxane group having a valency of (w2+1), and a group having a valency of (w2+1) and having an alkylene group between organopolysiloxane groups include groups shown below. Note that R^{a} in the below-shown formulas is the same as that described above. * indicates a bonding part.

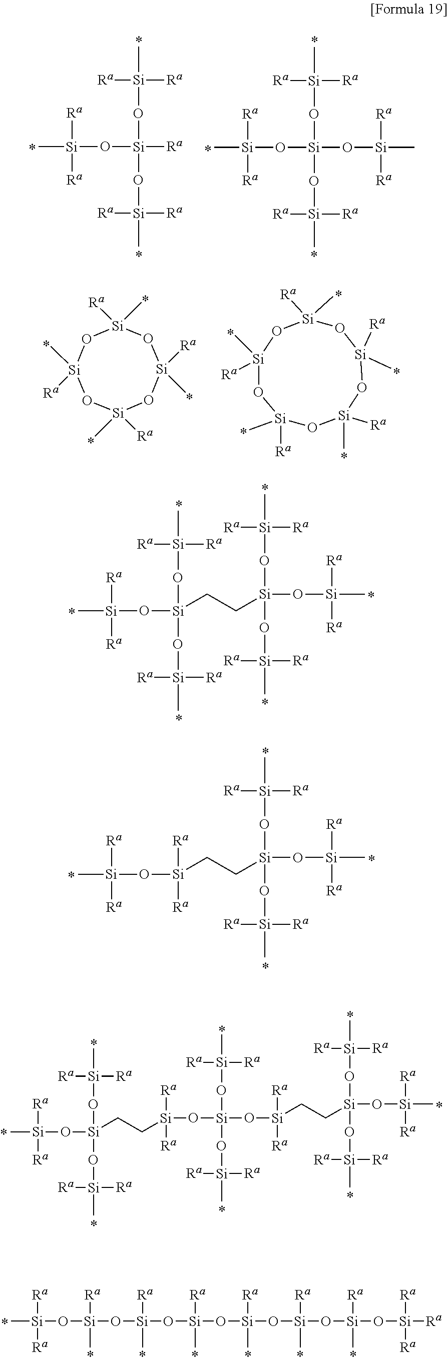

Q^{b6} is an alkylene group, or a group having an etheric oxygen atom or a divalent organopolysiloxane group between carbon atoms of an alkylene group containing two or more carbon atoms.

The number of carbon atoms of the alkylene group represented by Q^{b6} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having an etheric oxygen atom or a divalent organopolysiloxane group between carbon atoms of an alkylene group containing two or more carbon atoms and represented by Q^{b6} is preferably 2 to 20, more preferably 2 to 10, and still more preferably 2 to 6.

Q^{b6} is preferably —CH₂CH₂— or —CH₂CH₂CH₂— from the viewpoint of ease of the manufacturing of the compound.

The w2 [-Q^{b6}-J^{1](i.e., w}2 pieces of [-Qb6-J1]) may be the same as each other or different from each other.

Specific examples of the group (3-1A-6) include groups shown below. In the below-shown formula, * indicates a position of a bond with Z¹.

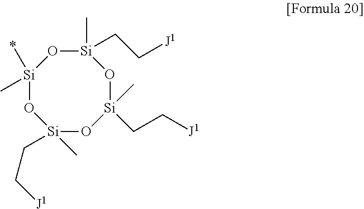

In the group (3-1A-7), Z^{e} is a hydrocarbon group having a valency of (w3+w4+1).

w3 is an integer of 4 or greater.

w4 is an integer of 0 or greater.

The definitions and the preferred ranges of Q^{e}, s4, Q^{a4}, t4, Q^{b4}, and u4 are the same as those of the same symbols in the group (3-1A-4).

Z^{e} may consist of a hydrocarbon chain, may have an etheric oxygen atom between carbon atoms of a hydrocarbon chain, and preferably consists of a hydrocarbon chain.

The valency of Z^{e} is preferably 5 to 20, more preferably 5 to 10, still more preferably 5 to 8, and particularly preferably 5 to 6.

The number of carbon atoms of Z^{e} is preferably 3 to 50, more preferably 4 to 40, and still more preferably 5 to 30,

w3 is preferably 4 to 20, more preferably 4 to 16, still more preferably 4 to 8, and particularly preferably 4 and 5.

w4 is preferably 0 to 10, more preferably 0 to 8, still more preferably 0 to 6, particularly preferably 0 to 3, and most preferably 0 and 1.

When there are two or more [—(O-Q^{b4})ᵤ₄-J¹], the two or more [—(O-Q^{b4})ᵤ₄-J¹] may be the same as each other or different from each other.

In the case where the end of Z¹ on the Q¹ side is an alkylene group, specific examples of the group (3-1A-7) include groups shown below. In the below-shown formula, * indicates a position of a bond with Z¹.

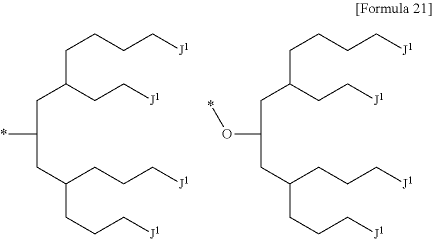

In the case where the end of Z¹ on the Q¹ side is an organopolysiloxane group, specific examples of the group (3-1A-7) include groups shown below. In the below-shown formula, * indicates a position of a bond with Z¹.

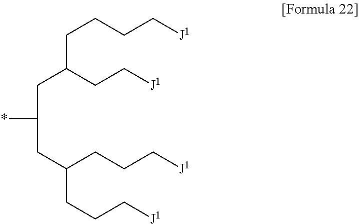

Q¹ may be a group (g2-1) (note that j1=d1+d3 and g1=d2+d4), a group (g2-2) (note that j1=e1 and g1=e2), a group (g2-3) (note that j1=1 and g1=2), a group (g2-4) (note that j11=h1 and g1=h2), a group (g2-5) (note that j1=i1 and g1=i2), a group (g2-6) (note that j1=1 and g1=1), or a group (g2-7) (note that j1=1 and g1=i3).

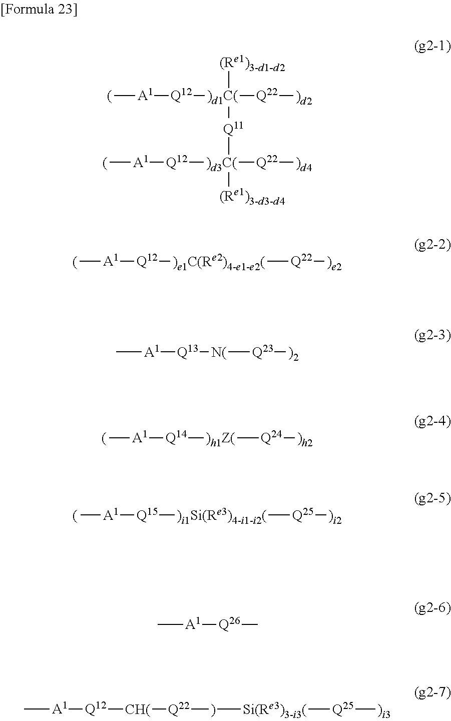

Note that in Formulas (g2-1) to (g2-7), the A¹ side is bonded to Z¹, and the Q²², Q²³, Q²⁴, Q²⁵ or Q²⁶ side is bonded to J¹.

A¹ is a single bond, —C(O)NR^{e6}—, —C(O)—, —OC(O)O—, —NHC(O)O—, —NHC(O)NR^{e6}—, —O— or SO₂NR^{e6}—.

When the end of Z on the side which is bonded to A¹ is an alkylene group, the end of A¹ on the side which is bonded to Z is not an alkylene group. Further, when Z is an organopolysiloxane group, the end of A¹ on the side which is bonded to Z is not an organopolysiloxane group.

Q¹² is a single bond, an alkylene group, or a group having —C(O)NR⁶—, —C(O)—, —NR⁶—, or O— between carbon atoms of an alkylene group containing two or more carbon atoms, and when there are two or more Q¹², the two or more Q¹² may be the same as each other or different from each other.

Q¹³ is a single bond (note that Q¹ is —C(O)—), an alkylene group, a group having —C(O)NR⁶—, —C(O)—, —NR⁶—, O— between carbon atoms of an alkylene group containing two or more carbon atoms, or a group having —C(O)— at the end on the N side of an alkylene group.

Q¹⁴ is Q¹² when the atom in Z to which Q¹⁴ is bonded is a carbon atom, and is Q¹³ when the atom in Z to which Q¹⁴ is bonded is a nitrogen atom. Further, when there are two or more Q¹⁴, the two or more Q¹⁴ may be the same as each other or different from each other.

Q¹⁵ is an alkylene group, or a group having —C(O)NR⁶—, —C(O)—, —NR⁶—, O— between carbon atoms of an alkylene group containing two or more carbon atoms, and when there are two or more Q¹⁵, the two or more Q¹⁵ may be the same as each other or different from each other. Q²² is an alkylene group, a group having —C(O)NR⁶—, —C(O)—, —NR⁶—, or O— between carbon atoms of an alkylene group containing two or more carbon atoms, a group having —C(O)NR⁶—, —C(O)—, —NR⁶—, or O— at the end of an alkylene group on the side which is not connected to Si, or a group having —C(O)NR⁶—, —C(O)—, —NR⁶—, O— between carbon atoms of an alkylene group containing two or more carbon atoms and having —C(O)NR⁶—, —C(O)—, —NR⁶—, or O— at the end on the side which is not connected to Si. Further, when there are two or more Q²², the two or more Q²² may be the same as each other or different from each other.

Q²³ is an alkylene group, or a group having —C(O)NR⁶—, —C(O)—, —NR⁶—, O— between carbon atoms of an alkylene group containing two or more carbon atoms. Further, the two Q²³ may be the same as each other or different from each other.

Q²⁴ is Q²² when the atom in Z to which Q²⁴ is bonded is a carbon atom, and is Q²¹ when the atom in Z to which Q²⁴ is bonded is a nitrogen atom. Further, when there are two or more Q²⁴, the two or more Q²⁴ may be the same as each other or different from each other.

Q²⁵ is an alkylene group, or a group having —C(O)NR⁶—, —C(O)—, —NR⁶—, O— between carbon atoms of an alkylene group containing two or more carbon atoms, and when there are two or more Q²⁵ the two or more pieces of Q²⁵ may be the same as each other or different from each other.

Q²⁶ is an alkylene group, or a group having —C(O)NR⁶—, —C(O)—, —NR⁶—, O— between carbon atoms of an alkylene group containing two or more carbon atoms.

When Q²², Q²³, Q²⁴, Q²⁵ and Q²⁶ are alkylene groups, the number of carbon atoms is preferably 1 to 20, more preferably 1 to 10, and still more preferably 1 to 6.

Z is a group having a ring structure having a valency of (h1+h2), and having a carbon atom or a nitrogen atom to which Q¹⁴ is directly bonded and having a carbon atom or a nitrogen atom to which Q²⁴ is directly bonded.

R^{e1} is a hydrogen atom or an alkyl group, and when there are two or more R^{e1}, the two or more R^{e1} may be the same as each other or different from each other.

R^{e2} is a hydrogen atom, a hydroxyl group, an alkyl group, or an acyloxy group.

R^{e3} is an alkyl group. R⁶ is a hydrogen atom, an alkyl group having a number of carbon atoms of 1 to 6.

d1 is an integer of 0 to 3, and preferably 1 or 2.

d2 is an integer of 0 to 3, and preferably 1 or 2.

d1+d2 is an integer of 1 to 3.

d3 is an integer of 0 to 3, and preferably 0 or 1.

d4 is an integer of 0 to 3, and preferably 2 or 3.

d3+d4 is an integer of 1 to 3.

d1+d3 is an integer of 1 to 5, and preferably 1 or 2.

d2+d4 is an integer of 1 to 5, and preferably 4 or 5.

e1+e2 is 3 or 4.

e1 is an integer of 1 to 3, and preferably 1 or 2.

e2 is an integer of 1 to 3, and preferably 2 or 3.

h1 is an integer of 1 or greater, preferably 1 or 2.

h2 is an integer of 1 or greater, and preferably 2 or 3.

i1+i2 is 3 or 4.

i1 is an integer of 1 to 3, and preferably 1 or 2.

i2 is an integer of 1 to 3, and preferably 2 or 3.

i3 is 2 or 3.

The number of carbon atoms of the alkylene groups of Q¹², Q¹³, Q¹⁴, Q¹⁵, Q²², Q²³, Q²⁴, Q²⁵ and Q²⁶ are preferably 1 to 30, more preferably 1 to 20, still more preferably 2 to 20, and may be 2 to 10 or 2 to 6 from the viewpoint of ease of the manufacturing of the compound and because the abrasion resistance of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

Examples of the ring structure in Z include the ring structures described above, and its preferred forms are also similar to those described above. Note that Q¹⁴ and Q²⁴ are directly bonded to the ring structure in Z, so that a situation in which, for example, the alkylene group is bonded to the ring structure, and Q¹⁴ and Q²⁴ are bonded to the alkylene group never occurs.

The number of carbon atoms of the alkyl group in R^{e1}, R^{e2} or R^{e3} is preferably 1 to 6, more preferably 1 to 3, and particularly preferably 1 to 2 from the viewpoint of ease of the manufacturing of the compound.

The number of carbon atoms of the alkylgroup moiety of the acyloxy group in R^{e2} is preferably 1 to 6, more preferably 1 to 3, and particularly preferably 1 to 2 from the viewpoint of ease of the manufacturing of the compound.

h1 is preferably 1 to 6, more preferably 1 to 4, still more preferably 1 to 2, and particularly preferably 1 from the viewpoint of ease of the manufacturing of the compound and because the abrasion resistance of the surface-treated layer becomes more excellent.

h2 is preferably 2 to 6, more preferably 2 to 4, and particularly preferably 2 or 3 from the viewpoint of ease of the manufacturing of the compound and because the abrasion resistance of the surface-treated layer becomes more excellent.

Examples of other forms of Q¹ include a group (g2-8) (note that j1=d1+d3 and g1=d2×k3+d4×k3), a group (g2-9) (note that j1=e1 and g1=e2×k3), a group (g2-10) (note that j1=1 and g1=2×k3), a group (g2-11) (note that j1=h1 and g1=h2×k3), a group (g2-12) (note that j1=i1 and g1=i2×k3), a group (g2-13) (note that j1=1 and g1=k3), or a group (g2-14) (note that j1=1 and g1=i3×k3.).

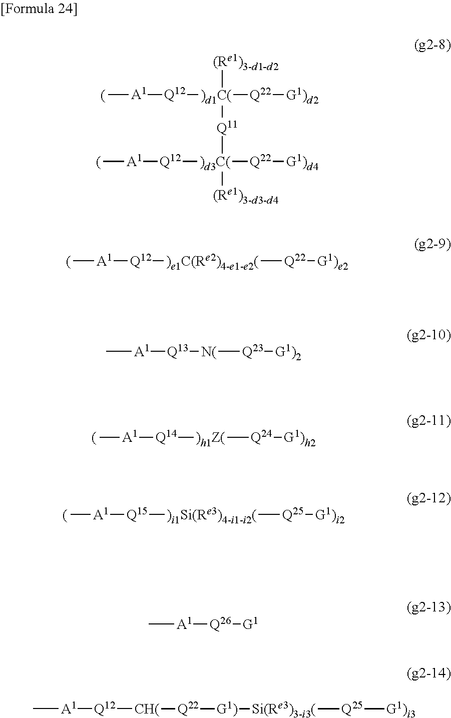

Note that in Formulas (g2-8) to (g2-14), the A¹ side is bonded to Z¹ and the G¹ side is bonded to J¹.

When the end of Z on the side which is bonded to A¹ is an alkylene group, the end of Q¹ on the side which is bonded to Z is not an alkylene group. Further, when Z is an organopolysiloxane group, the end of A¹ on the side which is bonded to Z is not an organopolysiloxane group.

G¹ is a group (g3) shown below, and two or more G¹ contained in Q may be the same as each other or different from each other. Symbols other than G¹ are similar to those in Formulas (g2-1) to (g2-7).

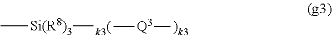

Note that in the group (g3), the Si side is connected to Q²², Q²³, Q²⁴, Q²⁵ and Q²⁶, and the Q³ side is connected to J¹. R⁸ is an alkyl group. Q³ is an alkylene group, a group having —C(O)NR⁶—, —(O)—, —NR⁶—, or —O— between carbon atoms of an alkylene group containing two or more carbon atoms, or (OSi(R⁹)₂)ₚ—O—, and two or more Q³ may be the same as each other or different from each other. k3 is two or three. R⁶ is a hydrogen atom, an alkyl group having a number of carbon atoms of 1 to 6. R⁹ is an alkyl group, a phenyl group, or an alkoxy group, and two R⁹ may be the same as each other or different from each other. p is an integer of 0 to 5. Further, when p is 2 or greater, the two or more (OSi(R⁹)₂) may be the same as each other or different from each other.

The number of carbon atoms of the alkylene group of Q³ is preferably 1 to 30, more preferably 1 to 20, still more preferably 2 to 20, and may be 2 to 10 or 2 to 6 from the viewpoint of ease of the manufacturing of the compound and because the abrasion resistance of the surface-treated layer becomes more excellent. For example, the number of carbon atoms is 2, 3, 8, 9 or 11. Further, the number of carbon atoms may be 1 to 10, 1 to 6, or 1 to 4. However, when the alkylene group has a specific bond between carbon atoms, the lower limit value of its number of carbon atoms is 2.

The number of carbon atoms of the alkyl group in R⁸ is preferably 1 to 6, more preferably 1 to 3, and still more preferably 1 to 2 from the viewpoint of ease of the manufacturing of the compound.

The number of carbon atoms of the alkyl group in R⁹ is preferably 1 to 6, more preferably 1 to 3, and still more preferably 1 to 2 from the viewpoint of ease of the manufacturing of the compound.

The number of carbon atoms of the alkoxy group in R⁹ is preferably 1 to 6, more preferably 1 to 3, and particularly preferably 1 to 2 because the storage stability of the compound becomes excellent.

p is preferably 0 or 1.

The compound according to the present disclosure is preferably, for example, a compound represented by Formula (4) shown below.

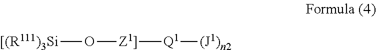

Note that each R¹¹¹ is independently an alkyl group or a trialkylsilyloxy group; Q¹ is —O—; and Z¹ is an organopolysiloxane group. This compound is preferred because it is industrially manufactured with each, is easy to handle, and because the water repellency and the abrasion resistance of the surface-treated layer are more excellent.

Examples of compounds according to the present disclosure include compounds represented by the below-shown formulas. The compounds represented by the below-shown formulas are preferred because they are industrially manufactured with each, are easy to handle, and because the water repellency and the abrasion resistance of the surface-treated layer are more excellent. R¹ in the compound represented by the below-shown formula is similar to that in [R¹¹-(Q)ᵣ₁-Z¹] in Formula (1), and its preferred forms are also similar to those described above.

In the case where the end of Z¹ on the side which is bonded to Q¹ is an alkylene group, examples of compounds in which Q¹ in Formula (1) is the group (g2-1) include compounds represented by the below-shown formula.

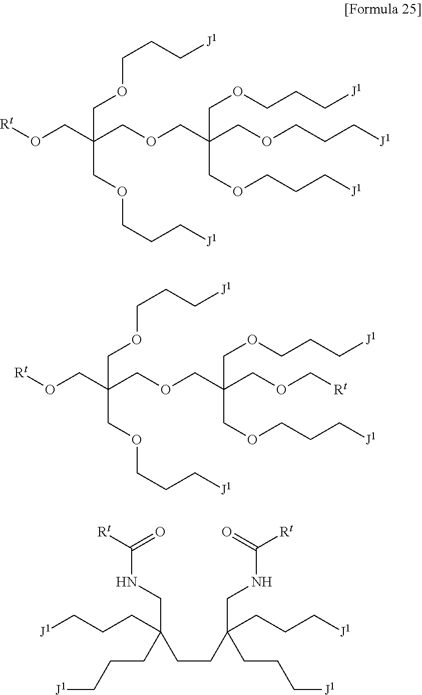

In the case where Z¹ is an organopolysiloxane group, examples of compounds in which Q¹ in Formula (1) is the group (g2-1) include compounds represented by the below-shown formula.

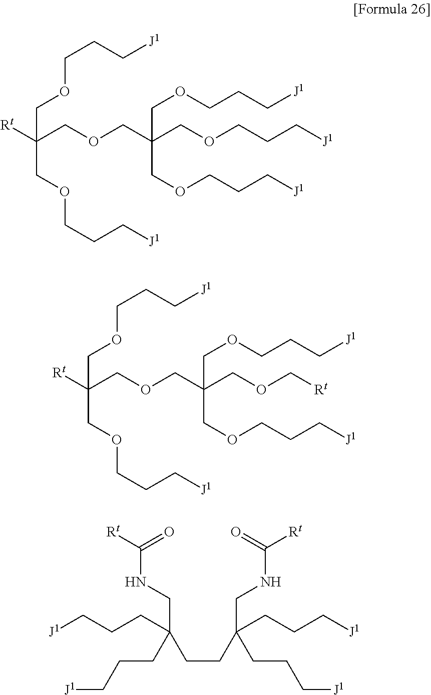

In the case where the end of Z¹ on the side which is bonded to Q¹ is an alkylene group, examples of compounds in which Q¹ in Formula (1) is the group (g2-2) include compounds represented by the below-shown formulas. In the below-shown formulas, Ak represents an alkyl group (e.g., an alkyl group having a number of carbon atoms of 1 to 15).

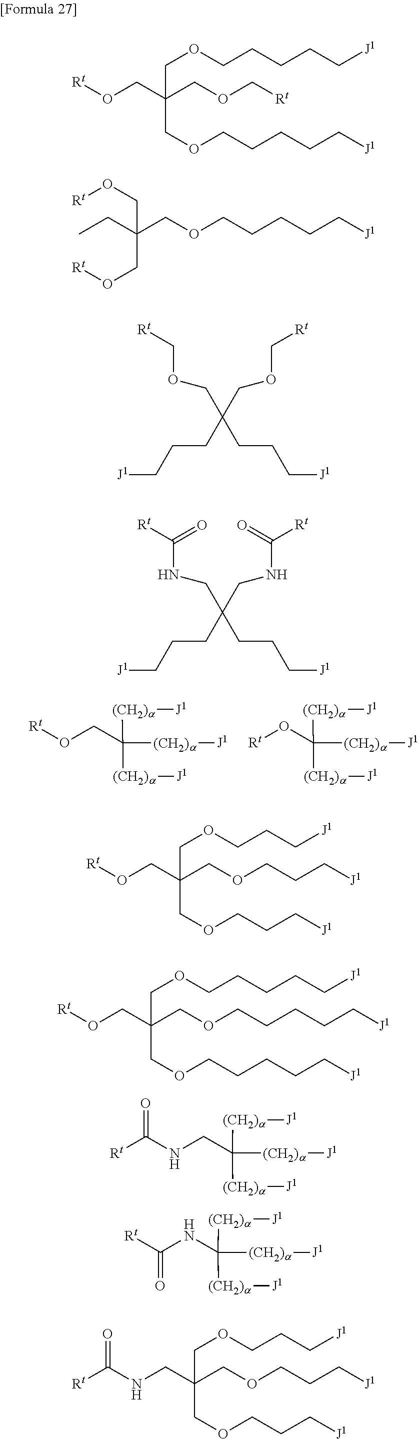

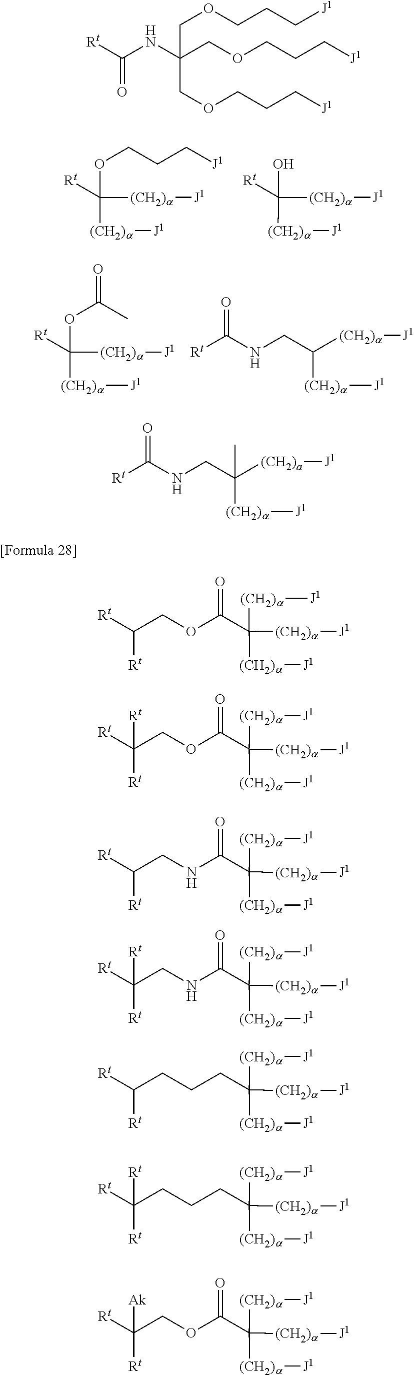

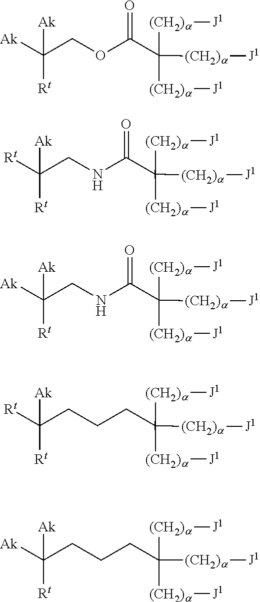

In the case where Z¹ is an organopolysiloxane group, examples of compounds in which Q¹ in Formula (1) is the group (g2-2) include compounds represented by the below-shown formulas.

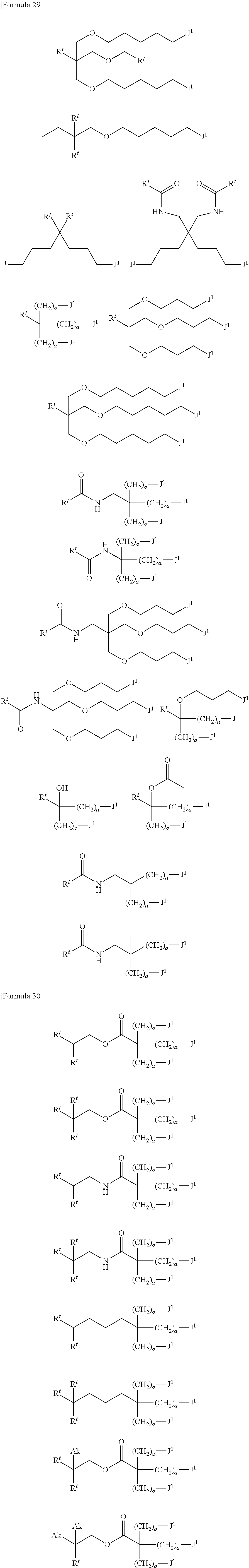

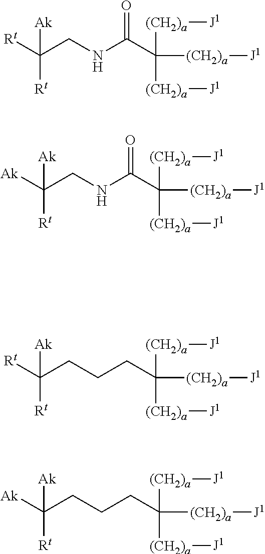

In the case where the end of Z¹ on the side which is bonded to Q¹ is an alkylene group, examples of compounds in which Q¹ in Formula (1) is the group (g2-3) include compounds represented by the below-shown formulas.

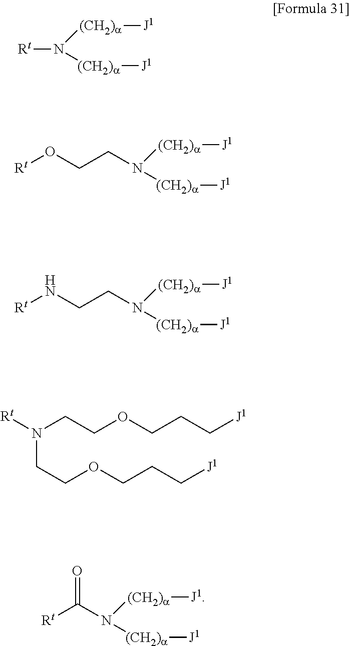

In the case where Z¹ is an organopolysiloxane group, examples of compounds in which Q¹ in Formula (1) is the group (g2-3) include compounds represented by the below-shown formulas.

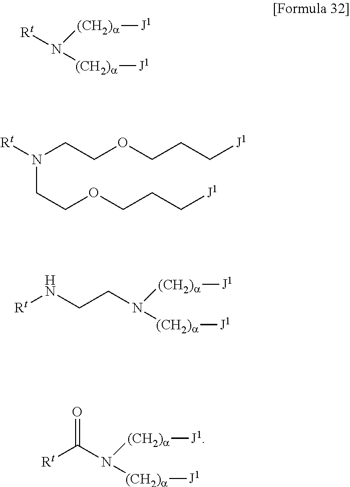

In the case where the end of Z¹ on the side which is bonded to Q¹ is an alkylene group, examples of compounds in which Q¹ in Formula (1) is the group (g2-4) include compounds represented by the below-shown formulas.

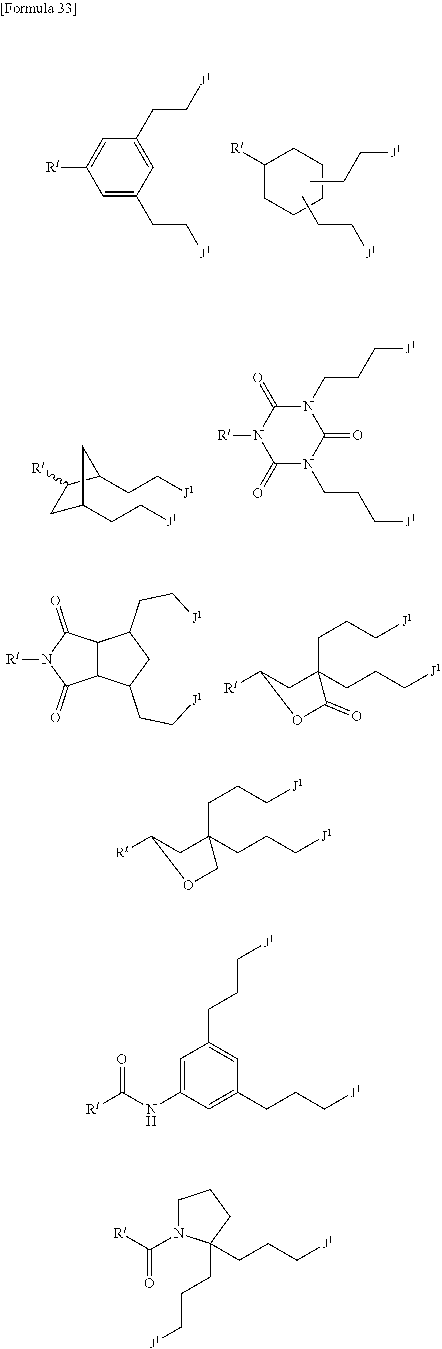

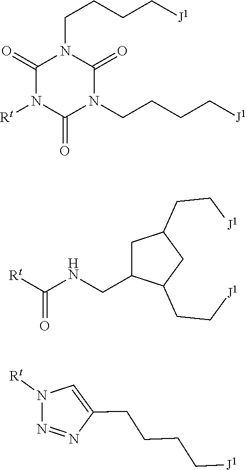

In the case where Z¹ is an organopolysiloxane group, examples of compounds in which Q¹ in Formula (1) is the group (g2-4) include compounds represented by the below-shown formulas.

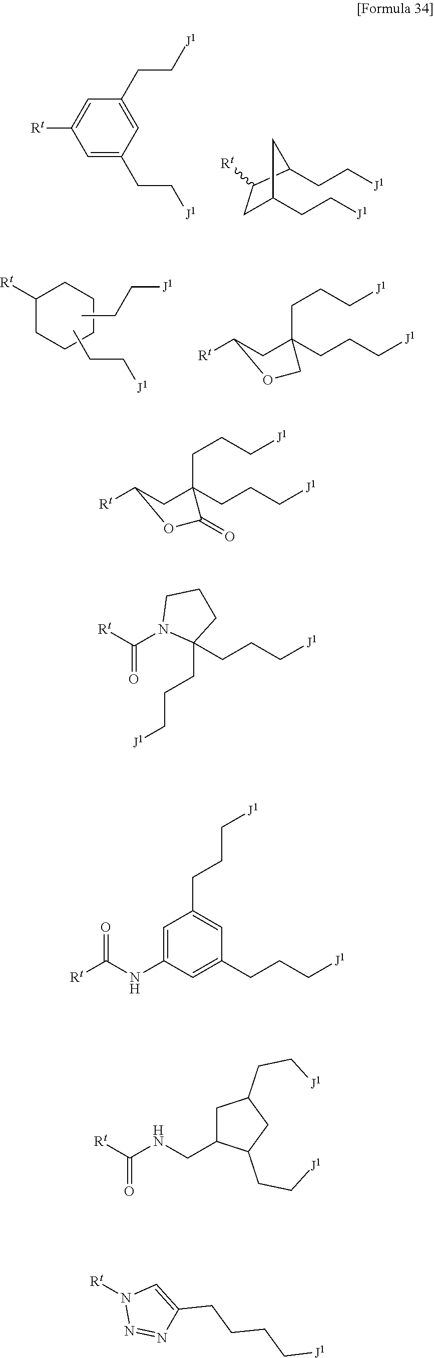

In the case where the end of Z¹ on the side which is bonded to Q¹ is an alkylene group, examples of compounds in which Q¹ in Formula (1) is the group (g2-5) include compounds represented by the below-shown formulas.

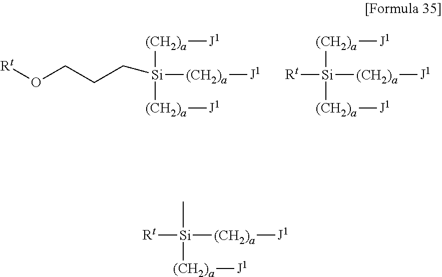

In the case where Z¹ is an organopolysiloxane group, examples of compounds in which Q¹ in Formula (1) is the group (g2-5) include compounds represented by the below-shown formulas.

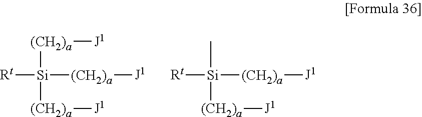

In the case where the end of Z¹ on the side which is bonded to Q¹ is an alkylene group, examples of compounds in which Q¹ in Formula (1) is the group (g2-6) include compounds represented by the below-shown formulas.

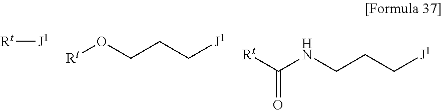

In the case where Z¹ is an organopolysiloxane group, examples of compounds in which Q¹ in Formula (1) is the group (g2-6) include compounds represented by the below-shown formulas.

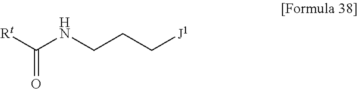

In the case where the end of Z¹ on the side which is bonded to Q¹ is an alkylene group, examples of compounds in which Q¹ in Formula (1) is the group (g2-7) include compounds represented by the below-shown formulas.

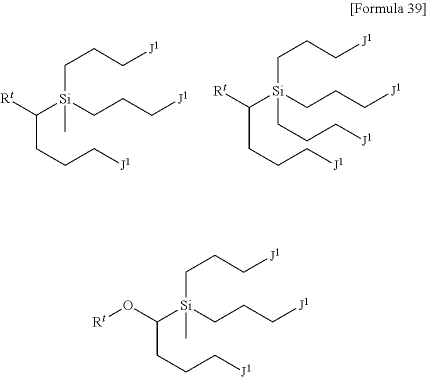

In the case where Z¹ is an organopolysiloxane group, examples of compounds in which Q¹ in Formula (1) is the group (g2-7) include compounds represented by the below-shown formulas.

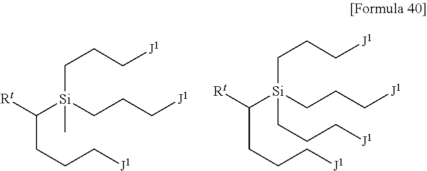

In the case where the end of Z¹ on the side which is bonded to Q¹ is an alkylene group, examples of compounds in which Q¹ in Formula (1) is the group (g2-8) include compounds represented by the below-shown formulas.

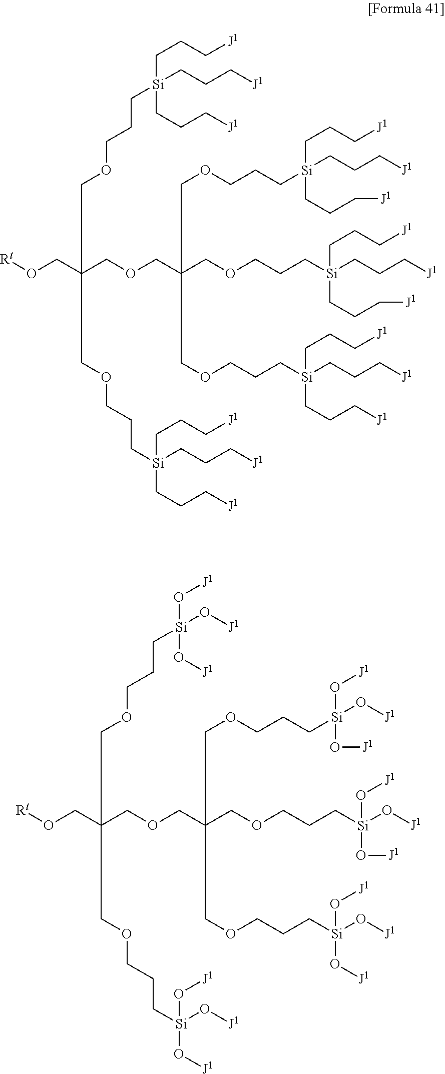

In the case where Z¹ is an organopolysiloxane group, examples of compounds in which Q¹ in Formula (1) is the group (g2-8) include compounds represented by the below-shown formulas.

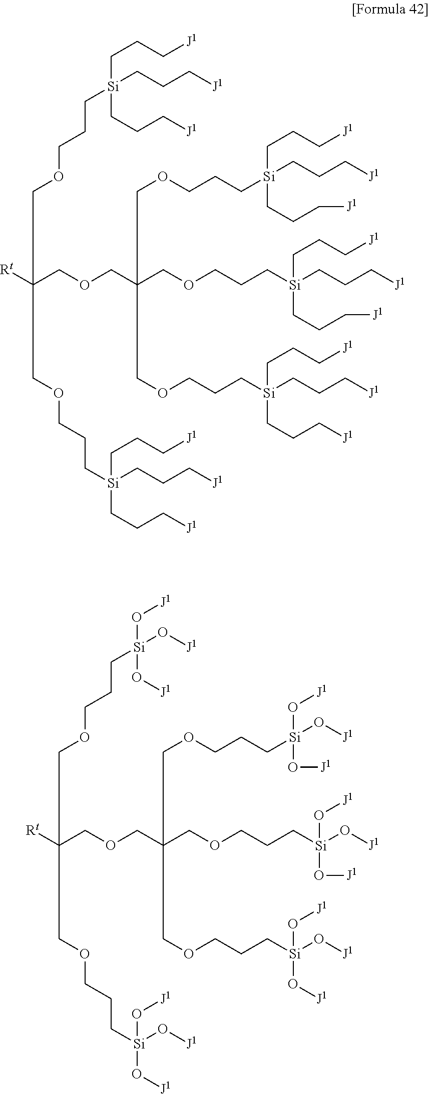

Examples of compounds in which Q¹ in Formula (1) is the group (g2-9) include compounds represented by the below-shown formulas.

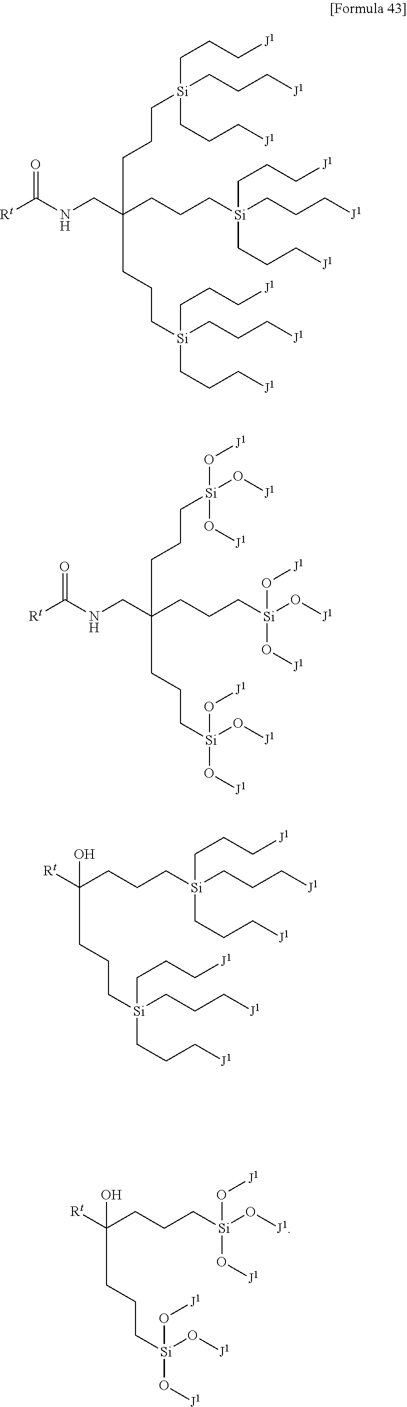

In the case where the end of Z¹ on the side which is bonded to Q¹ is an alkylene group, examples of compounds in which Q¹ in Formula (1) is the group (g2-10) include compounds represented by the below-shown formulas.

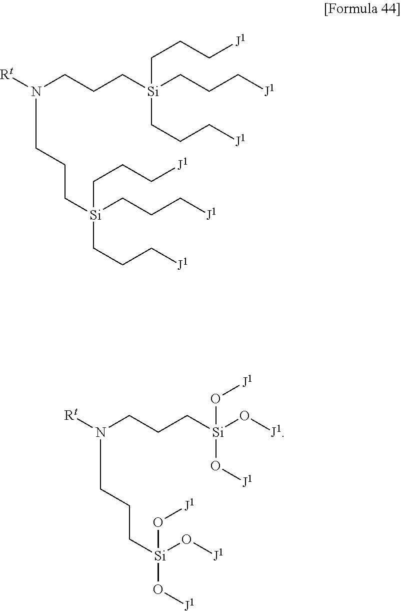

In the case where Z¹ is an organopolysiloxane group, examples of compounds in which Q¹ in Formula (1) is the group (g2-10) include compounds represented by the below-shown formulas.

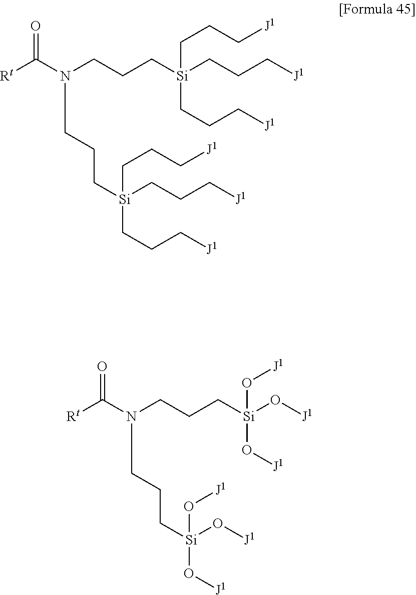

In the case where the end of Z¹ on the side which is bonded to Q¹ is an alkylene group, examples of compounds in which Q¹ in Formula (1) is the group (g2-11) include compounds represented by the below-shown formulas.

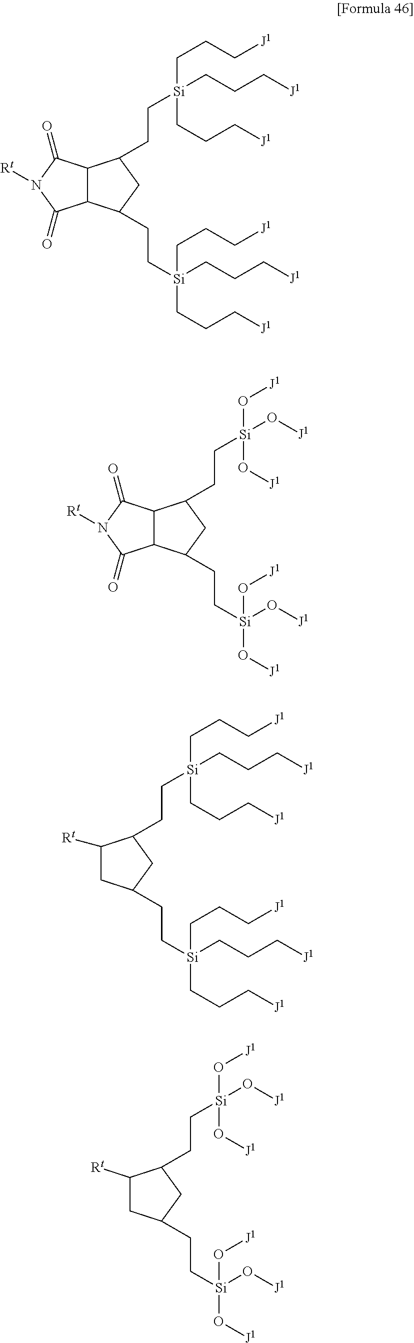

In the case where Z¹ is an organopolysiloxane group, examples of compounds in which Q¹ in Formula (1) is the group (g2-11) include compounds represented by the below-shown formulas.

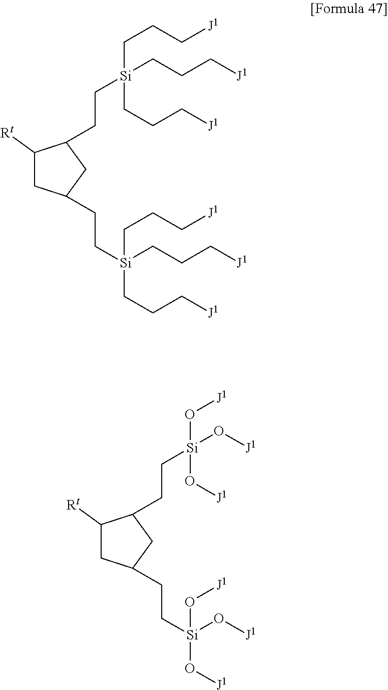

In the case where the end of Z¹ on the side which is bonded to Q¹ is an alkylene group, examples of compounds in which Q¹ in Formula (1) is the group (g2-12) include compounds represented by the below-shown formulas.

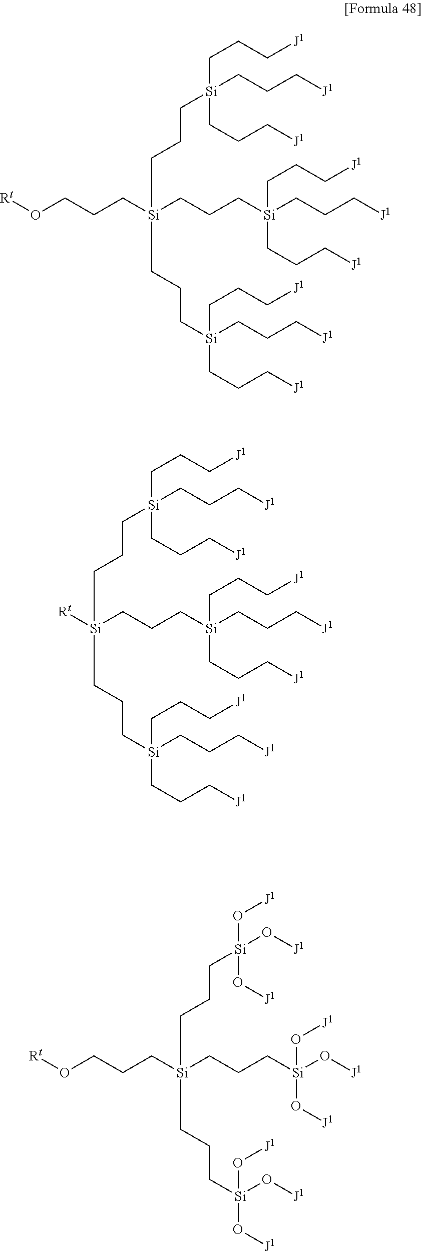

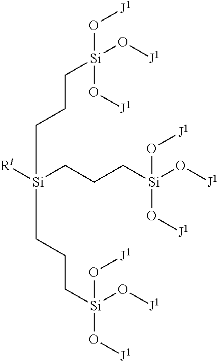

In the case where Z¹ is an organopolysiloxane group, examples of compounds in which Q¹ in Formula (1) is the group (g2-12) include compounds represented by the below-shown formulas.

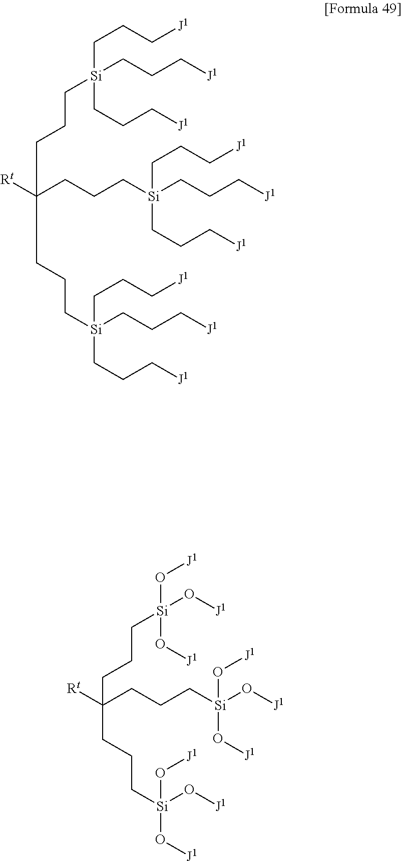

In the case where the end of Z¹ on the side which is bonded to Q¹ is an alkylene group, examples of compounds in which Q¹ in Formula (1) is the group (g2-13) include compounds represented by the below-shown formulas.

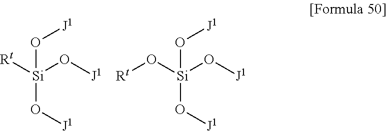

In the case where Z¹ is an organopolysiloxane group, examples of compounds in which Q¹ in Formula (1) is the group (g2-13) include compounds represented by the below-shown formulas.

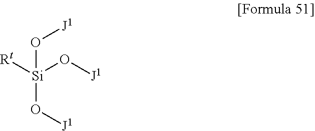

Examples of compounds in which Q¹ in Formula (1) is the group (g2-14) include compounds represented by the below-shown formulas.

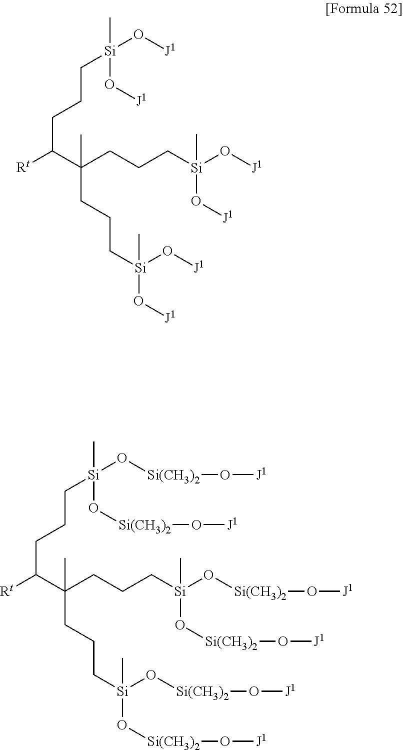

Specific examples of compounds according to the present disclosure include, but are not limited to, compounds shown below. Note that in the formula, n is an average value, and may be 1 or greater, and is preferably 2 to 500 and more preferably 3 to 300. Examples include 6, 13, 17, and 18. β in the formula is an integer representing the number of methylene groups, and is preferably 1 to 30, more preferably 1 to 20, still more preferably 4 to 20, and particularly preferably 5 to 15. Examples include 10, 11, 15, and 21. R is an alkylene group, and the number of carbon atoms is preferably 1 to 6, more preferably 1 to 3, and still more preferably 1 to 2.

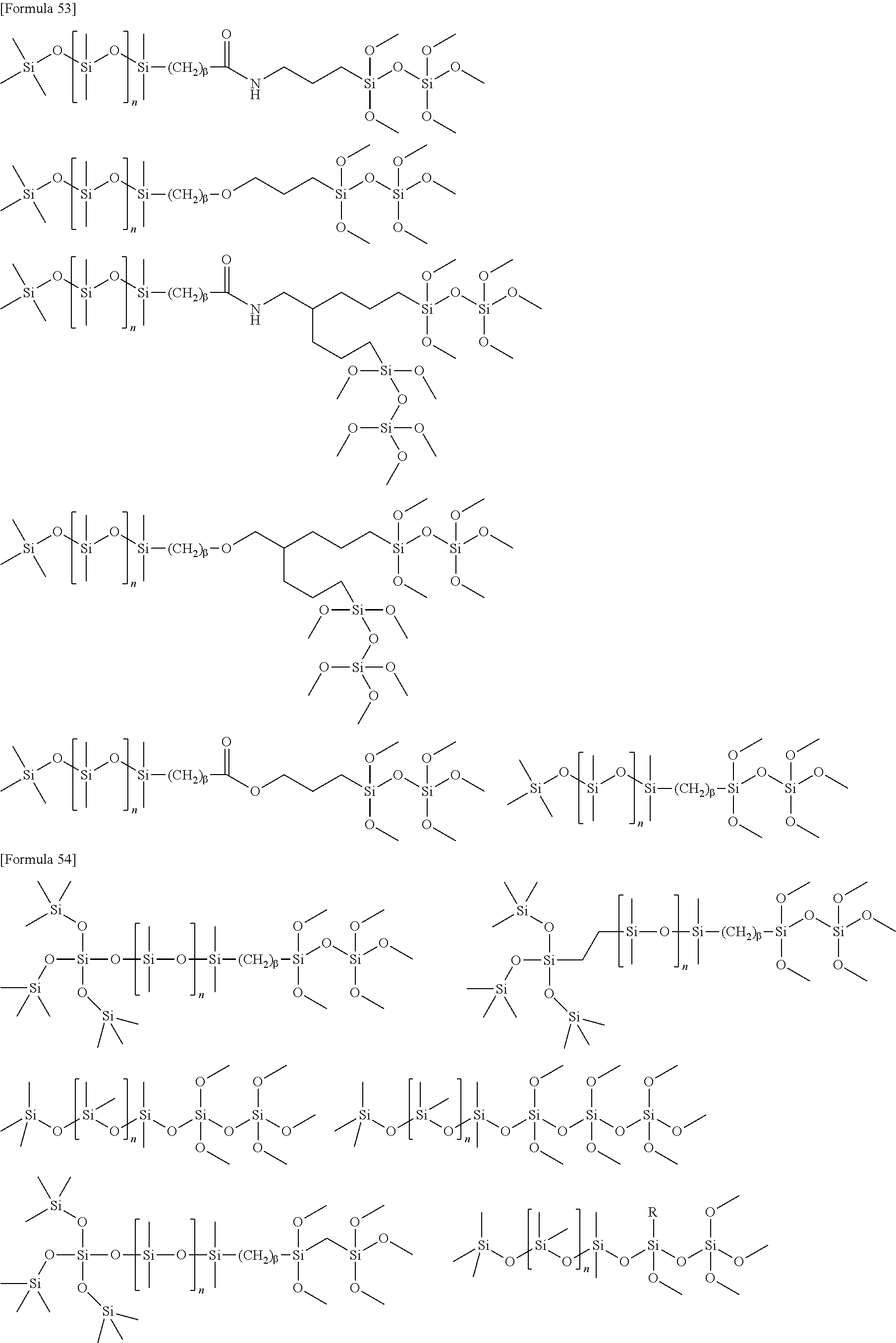

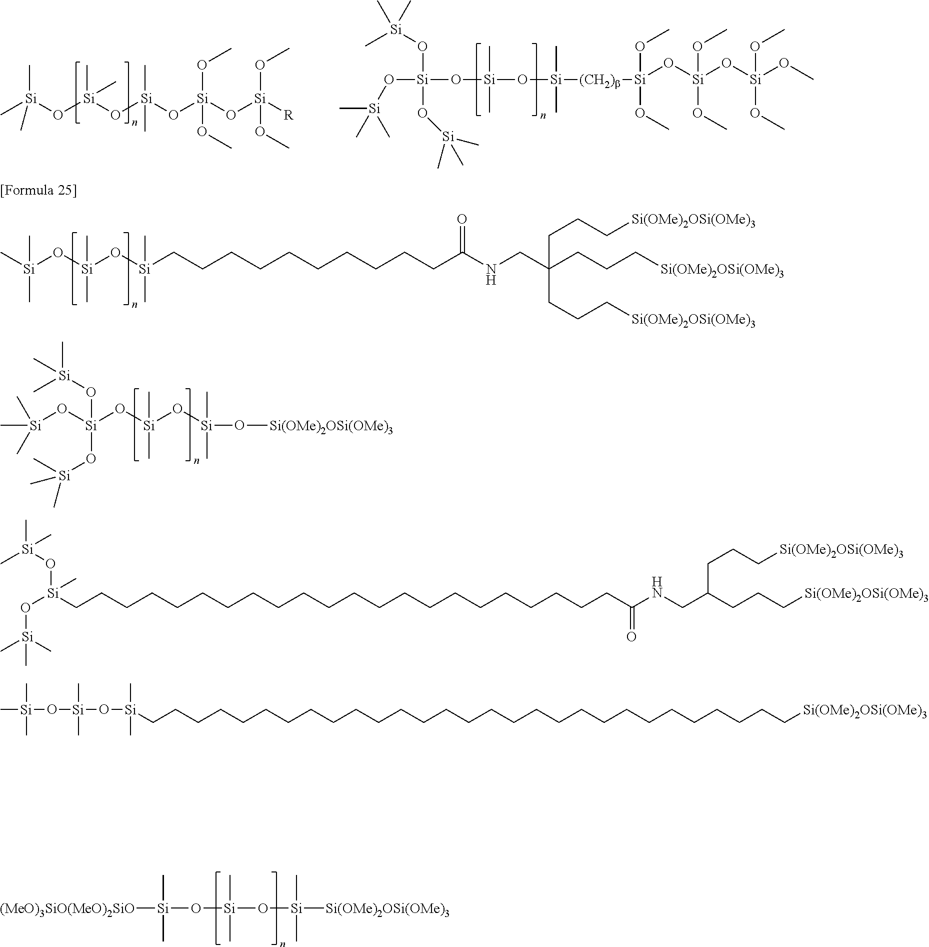

The number-average molecular weight (Mn) of a compound according to the present disclosure is preferably 500 to 20,000, more preferably 600 or 18,000, and still more preferably 700 or 15,000. When Mn is 500 or larger, the abrasion resistance of the surface-treated layer becomes more excellent.

When Mn is 20,000 or less, the viscosity can be easily adjusted within an appropriate range and the solubility is improved, so that the handling property during the film formation (i.e., during the deposition of the compound) becomes excellent.

### [Method for Manufacturing Compound]

The method for manufacturing the above-described compound disclosed herein is not limited to any particular methods. For example, the compound disclosed herein is obtained by introducing a group P into an organopolysiloxane corresponding to [R¹¹-(Q)ᵣ₁-Z¹]ₚ₁-Q¹¹ in Formula (1) by a known method. Note that Q¹¹ is obtained by using C═C instead of two carbon atoms at the end of Q¹, and the group P is introduced by using an intermediate H—[Si(R¹)₂—X]ₙ₁—Si(R¹)₃. Details of the intermediate H—[Si(R¹)₂—X]ₙ₁—Si(R¹)₃ will be described later. Further, the conditions for the reaction may be adjusted as appropriate with reference to examples described later.

Further, examples of the method for manufacturing a compound disclosed herein also include a method in which an organopolysiloxane group corresponding to [R¹¹-(Q)ᵣ₁-Z¹]ₚ₁—Si(R⁸)₂—H is reacted with R¹—[Si(R¹)₂—X]ₙ₁—Si(R¹)₃. Note that R⁸ is similar to R⁸ in the above-described group (A6). Specifically, an organopolysiloxane shown below in which the end is hydrogen is reacted with hexamethoxydisiloxane ((CH₃O)₃Si—O—Si(OCH₃)₃).

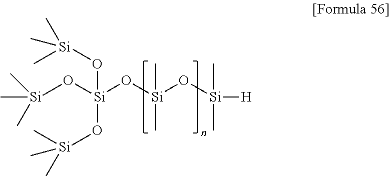

### [Composition]

It is sufficient if a composition according to the present disclosure contains a compound according to the present disclosure, and its components other than the compound according to the present disclosure are not limited to any particular components. The composition according to the present disclosure preferably contains the compound according to the present disclosure and a liquid medium. In the case where the composition according to the present disclosure contains a liquid medium, it is sufficient if the liquid medium is in a liquid state. That is, the liquid medium may be a solution or a dispersion liquid.

The composition according to the present disclosure may comprise at least one of a compound represented by Formula (1) and a compound represented by Formula (2). Note that the surface treatment agent according to the present disclosure may comprise both a compound represented by Formula (1) and a compound represented by Formula (2).

It is sufficient if the composition according to the present disclosure contains a compound according to the present disclosure, and the composition may also contain impurities such as by-products generated in the process for manufacturing the compound according to the present disclosure.

The content of the compound according to the present disclosure is preferably 0.001 to 40 mass %, more preferably 0.01 to 20 mass %, and still more preferably 0.1 to 10 mass % based on the total amount of the composition according to the present disclosure. In the case where the composition according to the present disclosure is used in a wet coating method, the content of the compound according to the present disclosure may be 0.01 to 10 mass %, 0.02 to 5 mass %, 0.03 to 3 mass %, or 0.05 to 2 mass % based on the total amount of the composition according to the present disclosure.

The composition according to the present disclosure may contain only one type of liquid medium, or may contain two or more types of liquid mediums.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane.

Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol-methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, dipropylene glycol monopropyl ether, dipropylene glycol monomethyl ether, tripropylene glycol monobutyl ether tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, diethylene glycol diethyl ether, diethylene glycol dimethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include halogen-based organic solvents, nitrogen-containing compounds, sulfur-containing compounds, siloxane compounds, and fluorine-containing organic solvents.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of fluorine-containing organic solvents include polyfluoro aromatic hydrocarbons (e.g., 1,3-bis(trifluoromethyl) benzene); polyfluoro aliphatic hydrocarbons (e.g., C₆F₁₃CH₂CH₃ (e.g., Asahikrin (Registered Trademark) AC-6000 manufactured by AGC Inc.)), 1,1,2,2,3,3,4-heptafluorocyclopentane (e.g., Zeorora (Registered Trademark) H manufactured by Zeon Corporation); hydrofluoroethers (HFE) (e.g., alkyl perfluoroalkyl ethers (perfluoroalkyl group and alkyl group may be linear chain or branched) such as perfluoropropyl methyl ether (C₃F₇OCH₃) (e.g., Novec (Registered Trademark) 7000 manufactured by 3M Japan Limited), perfluorobutyl methyl ether (C₄F₉OCH₃) (e.g., Novec (Registered Trademark) 7100 manufactured by 3M Japan Limited), perfluorobutyl ethyl ether (C₄F₉OC₂H₅) (e.g., Novec (Registered Trademark) 7200 manufactured by 3M Japan Limited), and perfluorohexyl methyl ether (C₂F₅CF(OCH₃)C₃F₇) (e.g., Novec (Registered Trademark) 7300 manufactured by 3M Japan Limited), and CF₃CH₂OCF₂CHF₂ (e.g., Asahikrin (Registered Trademark) AE-3000 manufactured by AGC Inc.,); and hydrofluoroolefins (HFO)(e.g., 1-chloro-2,3,3-trifluoro-1-propene (HCFO-1233yd) (e.g., Amolea (Registered Trademark) AS-300 manufactured by AGC Inc.,)).

The content of the liquid medium is preferably 60 to 99.999 wt. %, more preferably 80 to 99.99 wt. %, and still more preferably 90 to 99.9 wt. % based on the total amount of the composition according to the present disclosure. In the case where the composition according to the present disclosure is used in a wet coating method, the content of the liquid medium may be 90 to 99.99 wt. %, 95 to 99.98 wt. %, 97 to 99.97 wt. %, or 98 to 99.95 wt. % based on the total amount of the composition according to the present disclosure.

In addition to the compound according to the present disclosure and the liquid medium, the composition according to the present disclosure may contain other components in a range in which the effects of the present disclosure are not impaired.

Examples of the other components include known additives such as acid catalysts and basic catalysts that accelerate the hydrolysis and the condensation reaction of the group P.

As the catalyst, an arbitrary suitable acid or base, a transition metal (e.g., Ti, Ni, Sn, Zr, Al, or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide; and organic amines such as triethylamine and diethylamine.

Further, examples of the other components also include metal compounds having hydrolyzable groups (hereinafter, metal compounds having hydrolyzable groups are also referred to as “specific metal compounds”). When the composition according to the present disclosure contains a specific metal compound, the sliding property and the antifouling property of the surface-treated layer can be further improved. Examples of specific metal compounds include those represented by the below-shown Formulas (M1) to (M3).

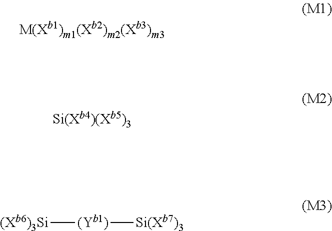

In Formula (M1),

M represents a trivalent or tetravalent metal atom.

Each X^{b1} independently represents a hydrolyzable group.

Each X^{b2} independently represents a siloxane skeleton-containing group.
Each X^{b3} independently represents a hydrocarbon chain-containing group.
m1 is an integer of 2 to 4,
each m2 and m3 independently represent an integer of 0 to 2, and
when M is a trivalent metal atom, m1+m2+m3 is 3, whereas when M is a tetravalent metal atom, m1+m2+m3 is 4.

In Formula (M2).
X^{b4} represents a hydrolyzable silane oligomer group.
Each X^{b5} independently represents a hydrolyzable group or an alkyl group having a number of carbon atoms of 1 to 4.

In Formula (M3),
each X^{b6} and X^{b7} independently represent a hydrolyzable group or a hydroxyl group.
Y^{b1} represents a divalent organic group.

The metal represented by M in Formula (M1) includes semimetals such as Si and Ge. M is preferably a trivalent metal and a tetravalent metal, more preferably Al, Fe, In, Hf, Si, Ti, Sn, and Zr, still more preferably Al, Si, Ti, and Zr, and particularly preferably Si.

Examples of the hydrolyzable group represented by X^{b1} in Formula (M1) include hydrolyzable groups similar to those represented by R1 in the group P.

The siloxane skeleton-containing group represented by X^{b2} has a siloxane unit (—Si—O—) and may be a linear chain or a branched chain. The siloxane unit is preferably a dialkylsilyloxy group, and examples include a dimethylsilyloxy group and a diethylsilyloxy group. The number of repetitions of the siloxane unit in the siloxane skeleton-containing group is 1 or greater, preferably 1 to 5, more preferably 1 to 4, and still more preferably 1 to 3.

The siloxane skeleton-containing group may contain a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a group having a hydrolyzable group, a hydrocarbon group (preferably an alkyl group), or the like may be bonded to a silicon atom at the end of the siloxane skeleton-containing group.

The number of elements of the siloxane skeleton-containing group is preferably 100 or smaller, more preferably 50 or smaller, and still more preferably 30 or smaller.

The number of elements is preferably 10 or greater. The siloxane skeleton-containing group is preferably a group represented by *—(O—Si(CH₃)₂)ₙCH₃, where n is an integer of 1 to 5 and * indicates a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be a linear chain or a branched chain, and is preferably a linear chain. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably 1 to 3, more preferably 1 to 2, and still more preferably 1. The hydrocarbon chain-containing group is preferably an alkyl group, and more preferably a methyl group, an ethyl group, or a propyl group.

m1 is preferably 3 or 4.

The compound represented by below-shown Formula (M1) is preferably compounds represented by the below-shown Formulas (M1-1) to (M1-5) in which M is Si, and more preferably a compound represented by the below-shown Formula (M1-1). The compound represented by the below-shown Formula (M1-1) is preferably tetraethoxysilane, tetramethoxysilane, or triethoxymethylsilane.

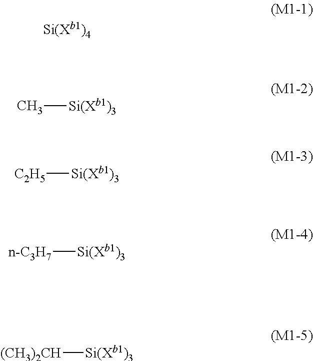

In Formula (M2), the number of silicon atoms contained in the hydrolyzable silane oligomer group represented by X^{b4} is preferably 3 or greater, more preferably 5 or greater, and still more preferably 7 or greater. The number of silicon atoms is preferably 15 or smaller, more preferably 13 or smaller, and still more preferably 10 or smaller.

The hydrolyzable silane oligomer group may have an alkoxy group that is bonded to a silicon atom. Examples of the alkoxy group include a methoxy group, an ethoxy group, a propoxy group, and a butoxy group. Further, the alkoxy group is preferably a methoxy group or an ethoxy group. The hydrolyzable silane oligomer group may have one or two or more types of alkoxy groups, and preferably has one type of alkoxy group.

Examples of the hydrolyzable silane oligomer group include (C₂H₅O)₃Si—(OSi(OC₂H₅)₂)₄O—*. Note that * indicates a part bonded to an adjacent atom.

Examples of the hydrolyzable group represented by X^{b5} in Formula (M2) include hydrolyzable groups similar to those represented by R1 in the group P, a cyano group, a hydrogen atom, and an allyl group. Further, the hydrolyzable group is preferably an alkoxy group or an isocyanato group. The alkoxy group is preferably an alkoxy group having a number of carbon atoms of 1 to 4.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both ends of a divalent organic group, i.e., is bissilane.

Examples of the hydrolyzable groups represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. Further, the hydrolyzable groups are preferably alkoxy groups or isocyanato groups. The alkoxy group is preferably an alkoxy group having a number of carbon atoms of 1 to 4, and more preferably a methoxy group or an ethoxy group.

In Formula (M3), X^{b6} and X^{b7} may be the same groups as each other or groups different from each other. In view of the availability, X^{b6} and X^{b7} are preferably the same groups as each other.

In Formula (M3), Y^{b1} is a divalent organic group connecting reactive silyl groups at both ends. The number of carbon atoms of Y^{b1} of the divalent organic group is preferably 1 to 8 and more preferably 1 to 3.

Examples of Y^{b1} include an alkylene group, a phenylene group, and an alkylene group having an etheric oxygen atom between carbon atoms. Examples include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of other components which may be contained in the composition according to the present disclosure is preferably 10 mass % or less and more preferably 1 mass % or less based on the total amount of the composition according to the present disclosure. When the composition according to the present disclosure contains a specific metal compound, the content of the specific metal compound is preferably 0.01 to 30 mass %, more preferably 0.01 to 10 mass %, and still more preferably 0.05 to 5 mass % based on the total amount of the composition according to the present disclosure.

The total content (hereinafter also referred to as “solid content concentration”) of the compound according to the present disclosure and the other components is preferably 0.001 to 40 wt. %, more preferably 0.01 to 20 wt. %, and still more preferably 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at 120° C. for 4 hours.

Since the composition according to the present disclosure contains a liquid medium, it is useful for use in which the composition is used for coating, and can be used as a coating liquid.

Examples of the other components include compounds represented by below-shown Formula (5).

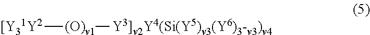

In Formula (5), Y² is Si, Sn, or Ge,
each Y¹ is independently a hydrocarbon group or a trialkylsilyloxy group,
v1 is 0 or 1,
each Y³ is independently an alkylene chain or a polyalkylene oxide chain, or a combination of an alkylene chain and a divalent polysiloxane residue,
Y⁴ is a single bond or a linking group having a valency of (v2+v4),
each Y⁵ is independently a hydrocarbon group,
each Y⁶ is independently a hydrolyzable group or a hydroxyl group,
each v3 is independently an integer of 0 to 2, and
each v2 and each v4 are independently an integer of 1 or greater.

A compound in which Y³ is an alkylene chain or a polyalkylene oxide chain is preferred as the compound (which may contain an etheric oxygen atom between carbon atoms).

Specific examples of the compound (5) include compounds shown below. γ in the formula is preferably 9 to 50, more preferably 11 to 30, and particularly preferably 11 to 25.

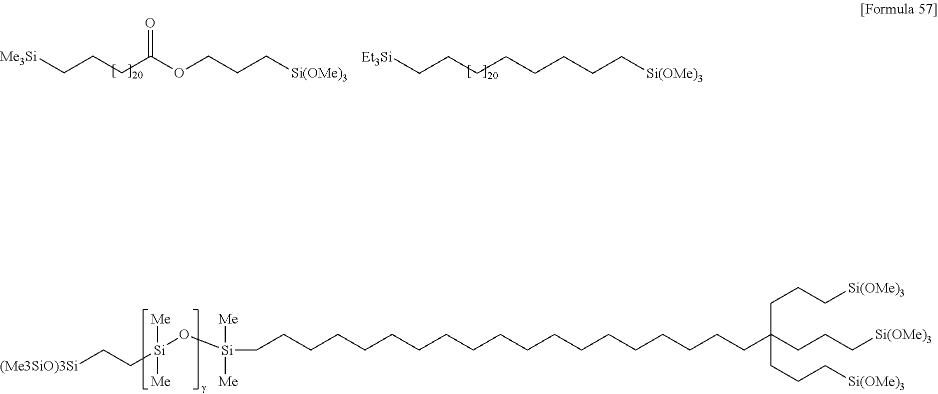

When the other component in the surface treatment agent disclosed herein is the compound (5), the content of the compound (5) is preferably 50 mass % or less and more preferably 40 mass % or less.

### [Surface Treatment Agent]

In an embodiment, a surface treatment agent according to the present disclosure contains a compound according to the present disclosure. Further, a surface treatment agent according to the present disclosure may contain a compound according to the present disclosure and a liquid medium. A surface treatment agent according to the present disclosure may be a composition according to the present disclosure. Preferred embodiments of the liquid medium contained in the surface treatment agent according to the present disclosure are similar to those of the liquid medium contained in the composition according to the present disclosure.

The compound according to the present disclosure contains an alkyl group having a number of carbon atoms of 2 or greater, an organopolysiloxane group, and the group P. Therefore, by using the surface treatment agent containing the compound according to the present disclosure, a surface-treated layer with excellent water repellency and excellent abrasion resistance can be formed.

The surface treatment agent according to the present disclosure may comprise at least one of a compound represented by Formula (1) and a compound represented by Formula (2). Note that the surface treatment agent according to the present disclosure may comprise both a compound represented by Formula (1) and a compound represented by Formula (2).

In particular, the surface treatment agent according to the present disclosure is preferably used for an optical member.

### [Article]

In an embodiment, an article according to the present disclosure includes a substrate and a surface-treated layer which is disposed on the substrate and of which the surface is treated with a surface treatment agent according to the present disclosure.

The surface-treated layer may be formed on a part of the surface of the substrate or over the entire surface of the substrate. The surface-treated layer may be spread in the form of a film on the surface of the substrate or scattered in the form of dots.

In the surface-treated layer, the compound according to the present disclosure is contained therein in a state in which the hydrolysis of some or all of groups P have progressed and the dehydration condensation reaction of silanol groups have progressed.

The thickness of the surface-treated layer is preferably 1 to 100 nm and more preferably 1 to 50 nm. When the thickness of the surface-treated layer is 1 nm or larger, the effects of the surface treatment are likely to be obtained satisfactorily. When the thickness of the surface-treated layer is 100 nm or smaller, the usage efficiency is high. The thickness of the surface-treated layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, ceramics, and composite materials thereof. The glass may be one that is chemically reinforced.

Examples of substrates including building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface-treated layer, and the abrasion resistance of the surface-treated layer is further improved. Therefore, it is preferred to perform a surface treatment on the surface of the substrate on the side which is brought into contact with the surface-treated layer. Further, in the case where an underlayer (which will be described later) is provided, the substrate subjected to the surface treatment has a more excellent adhesive property for the underlayer, and the abrasion resistance of the surface-treated layer is further improved. Therefore, in the case where an underlayer is provided, it is preferred to perform a surface treatment on the surface of the substrate on the side which is brought into contact with the underlayer.

The surface-treated layer may be directly disposed on the surface of the substrate, or an underlayer may be provided between the substrate and the surface-treated layer. In order to further improve the water repellency and the abrasion resistance of the surface-treated layer, an article according to the present disclosure preferably includes a substrate, an underlayer disposed on the substrate, and a surface-treated layer which is disposed on the underlayer and of which the surface is treated with a surface treatment agent according to the present disclosure.

The underlayer is preferably a layer containing an oxide containing silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to simply as “Group 1 elements”) refer to lithium, sodium, potassium, rubidium, and cesium. Group 1 elements are preferably lithium, sodium, and potassium, and more preferably sodium and potassium because the surface-treated layer can be formed more uniformly on the underlayer without defects or because variations in the composition of the underlayer among samples are more suppressed. The underlayer may contain two or more Group 1 elements.

Group 2 elements in the periodic table (hereinafter also referred to simply as “Group 2 elements”) refer to beryllium, magnesium, calcium, strontium, and barium. Group 2 elements are preferably magnesium, calcium, and barium, and more preferably magnesium and calcium because the surface-treated layer can be formed more uniformly on the underlayer without defects or because variations in the composition of the underlayer among samples are more suppressed. The underlayer may contain two or more Group 2 elements.

Group 4 elements in the periodic table (hereinafter also referred to simply as “Group 4 elements”) refer to titanium, zirconium, and hafnium Group 4 elements are preferably titanium and zirconium, and more preferably titanium because the surface-treated layer can be formed more uniformly on the underlayer without defects or because variations in the composition of the underlayer among samples are more suppressed. The underlayer may contain two or more Group 4 elements.

Group 5 elements in the periodic table (hereinafter also referred to simply as “Group 5 elements”) refer to vanadium, niobium, and tantalum. Group 5 elements are particularly preferably vanadium because the abrasion resistance of the surface-treated layer becomes more excellent. The underlayer may contain two or more Group 5 elements.

Group 13 elements in the periodic table (hereinafter also referred to simply as “Group 13 elements”) refer to boron, aluminum, gallium, and indium. Group 13 elements are preferably boron, aluminum, and gallium, and more preferably boron and aluminum because the surface-treated layer can be formed more uniformly on the underlayer without defects or because variations in the composition of the underlayer among samples are more suppressed. The underlayer may contain two or more Group 13 elements.

Group 15 elements in the periodic table (hereinafter also referred to simply as “Group 15 elements”) refer to nitrogen, phosphorus, arsenic, antimony, and bismuth. Group 15 elements are preferably phosphorus, antimony, and bismuth, and more preferably phosphorus and bismuth because the surface-treated layer can be formed more uniformly on the underlayer without defects or because variations in the composition of the underlayer among samples are more suppressed. The underlayer may contain two or more Group 15 elements.

The specific element contained in the underlayer is preferably a Group 1 element, a Group 2 element, and a Group 13 element, more preferably a Group 1 element and a Group 2 element, and still more preferably a Group 1 element because the abrasion resistance of the surface-treated layer becomes more excellent.

Only one element or two or more elements may be contained as the specific element(s).

The oxide contained in the underlayer may be a mixture of oxides each containing only one of the aforementioned elements (silicon and specific element) (e.g., a mixture of silicon oxide and an oxide of a specific element), a composite oxide containing two or more of the aforementioned elements, or a mixture of an oxide containing only one of the aforementioned elements and a composite oxide.

The ratio of the total molarity of the specific element in the underlayer to the molarity of silicon in the underlayer (specific element/silicon) is preferably 0.02 to 2.90, more preferably 0.10 to 2.00, and still more preferably 0.20 to 1.80 because the abrasion resistance of the surface-treated layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer. The underlayer may have an uneven surface(s).

The thickness of the underlayer is preferably 1 to 100 nm, more preferably 1 to 50 nm, and still more preferably 2 to 20 nm. When the thickness of the underlayer is equal to or larger than the aforementioned lower limit value, the adhesive property of the surface-treated layer by the underlever is further improved, so that the abrasion resistance of the surface-treated layer becomes more excellent. When the thickness of the underlayer is equal to or smaller than the aforementioned upper limit value, the abrasion resistance of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably contains silicon and an oxide containing a specific element.

Specific examples of the form of the vapor-deposition material include a powder, a molten material, a sintered compact, granules, and a crushed material. Further, a molten material, a sintered compact, and granules are preferred in view of the handling property.

Note that the molten material refers to a solid material obtained by melting a powder of a vapor-deposition material at a high temperature, and then cooling and solidifying the molten vapor-deposition material. The sintered compact refers to a solid material obtained by firing a powder of a vapor-deposition material. Further, if necessary, instead of the powder of the vapor-deposition material, a molded compact formed by press-molding such a powder may be used. The granules refers to a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder containing silicon (e.g., a powder made of silicon oxide, silica sand, or silica gel), a powder containing a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a mixture obtained by mixing a powder containing silicon (e.g., a powder made of silicon oxide, silica sand, or silica gel), a powder containing a specific element (e.g., a powder of an oxide of a specific element, a carbonate, a sulfate, a nitrate, an oxalate, or a hydroxide), and water at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably 100 to 3,000° C. and more preferably 500 to 3,000° C.

The pressure during the vapor-deposition (e.g., in the case where a vacuum deposition apparatus is used, the pressure in a chamber in which the deposition material is disposed) is preferably 1 Pa or lower and more preferably 0.1 Pa or lower.

When an underlayer is formed by using a vapor-deposition material, one vapor-deposition material may be used, or two or more vapor-deposition materials containing different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated. As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid containing a compound containing silicon, a compound containing a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds containing a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those similar to liquid mediums contained in the composition according to the present disclosure.

The content of the liquid medium is preferably 0.01 to 20 mass % and more preferably 0.1 to 10 mass % based on the total amount of the coating liquid used for the formation of the underlayer.

Specific examples of wet coating methods for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the substrate or the like is wet-coated with the coating liquid, the coating is preferably dried. The drying temperature of the coating is preferably 20 to 200° C. and more preferably 80 to 160° C.

The article according to the present disclosure may be an optical material including a surface-treated layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, and those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a member for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer.

Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO), indium zinc oxide, or the like, may be provided on a part of the surface of the substrate (glass). Further, the substrate may also include an insulating layer, an adhesive layer, a protective layer, a decorative frame layer (I-CON), an atomization film layer, a hard coating film layer, a polarizing film, a phase difference film, a liquid crystal display module, or the like according to its specific specifications.

### [Method for Manufacturing Article]

A method for manufacturing an article according to the present disclosure is, for example, a method for manufacturing an article including a surface-treated layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound according to the present disclosure may be used. A pellet-like substance, which is obtained by impregnating a porous material made of a metal such as iron or steel with a composition containing a compound according to the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the abrasion resistance of the surface-treated layer, when necessary, an operation for accelerating the reaction between the compound according to the present disclosure and the substrate may be performed. Examples of such operations include heating, humidification, and irradiation with light.

For example, it is possible to accelerate, by heating a substrate on which a surface-treated layer is formed in an atmosphere containing moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface-treated layer and are not chemically bonded to other compounds nor the substrate may be removed as required. Examples of removal methods include a method in which a solvent is poured over the surface-treated layer, and a method in which the surface-treated layer is wiped with a cloth impregnated with a solvent.

### [Intermediate]

An intermediate according to the present disclosure is represented by Formula (3) shown below.

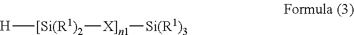

where: each X is independently an oxygen atom or a carbon atom; each R¹ is independently a hydrolyzable group, a group having a hydrolyzable group, a hydroxyl group, or a hydrocarbon group; at least four of R¹ are hydrolyzable groups, groups having a hydrolyzable group, or hydroxyl groups; and n1 is an integer of 1 to 3. The definitions of X and R¹ are synonymous with the definitions definition described above for X and R¹ in the group P.

The intermediate according to the present disclosure is useful as an intermediate of a compound according to the present disclosure which is suitably used for a surface treatment agent.

### EXAMPLES

The present invention will be described hereinafter in a more detailed manner by using examples, but the present invention is not limited to these examples. Note that Examples 1 and 2 are comparative examples, and Examples 3 to 7 are example according to the present disclosure.

### [Synthesis of Compound (11)]

A compound (11) was obtained according to a method disclosed in International Patent Publication No. WO 2023/017830. The average value of the numbers n of repetitive units was 17.

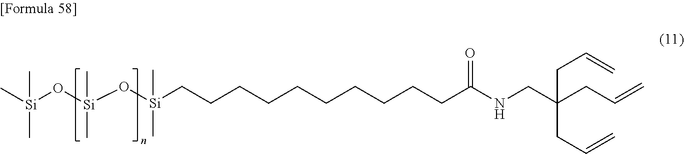

### [Synthesis of Compound (12)]

A compound (12) was obtained according to a method disclosed in International Patent Publication No. WO 2023/017830. The average value of the numbers n of repetitive units was 17.

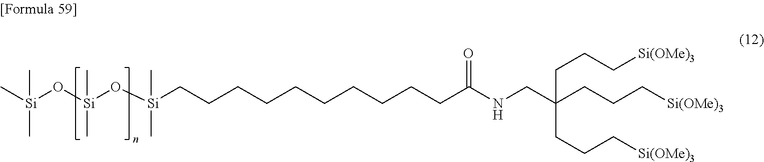

### [Synthesis of Compound (13)]

A compound (13) was obtained according to a method disclosed in International Patent Publication No. WO2021/187184. The average value of the numbers n of repetitive units was 17.

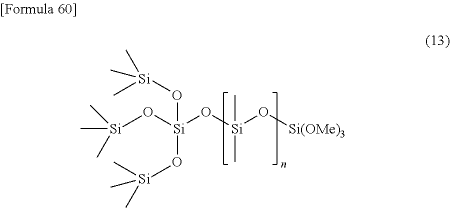

### [Synthesis of Compound (14)]

Tris (triphenylphosphine) rhodium (I) chloride (0.05 g), toluene (30 g), and molecular sieves 5A (20 g) were added to trimethoxysilane (10 g), and the mixture was heated and refluxed at 110° C. for 24 hours. After removing the molecular sieves by filtration, 2.5 g of a compound (14) was obtained by distillation and purification. The structure of the compound (14) was confirmed from NMR data shown below.

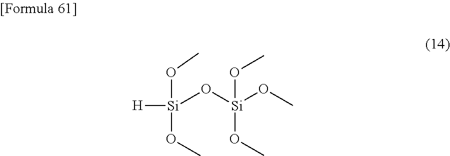

¹H-NMR (400 MHz, CDCl₃) δ4.31 (s, 1H), 3.68-3.55 (m, 15H).

### [Synthesis of Compound (15)]

A toluene solution of a platinum/1,3-divinyl-1,1,3,3-tetramethyldisiloxane complex (platinum content: 3 mass %, 4.1 mg), aniline (2.6 mg), and the compound (14) (0.82 g) were added to the compound (11) (0.85 g) dissolved in dichloromethane (10 g), and the mixture was stirred at 50° C. for 2 hours. 1.25 g of a compound (15) was obtained by removing the solvent by distillation under a reduced pressure. The average value of n in the compound (15) was 17. The structure of the compound (15) was confirmed from NMR data shown below.

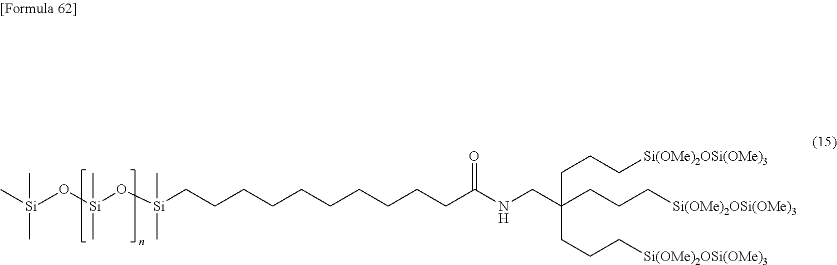

¹H-NMR (400 MHz, CDCl₃) δ3.76-3.26 (m, 45H), 3.04 (dd, J=6.0, 5.3 Hz, 2H), 2.28-0.39 (m, 38H), 0.20-0.24 (m, 117H).

### [Synthesis of Compound (16)]

A compound (16) was obtained according to a method disclosed in Japanese Unexamined Patent Application Publication No. 2017-119849.

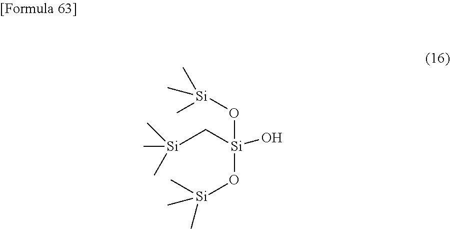 [SMILES: C[Si](C)(C)C[Si](O)(O[Si](C)(C)C)O[Si](C)(C)C]

### [Synthesis of Compound (17)]

THF (tetrahydrofuran, 10 g) was added to the compound (16) (2.2 g), and the mixture was made homogeneous. Then, the mixture was cooled to 0° C.; a butyllithium solution (THF solution, 1.6 M) (4.0 mL) was added to the resultant solution; and the mixture was stirred at 0° C. for 15 minutes. Next, hexamethylcyclotrisiloxane (8.0 g) was added, and the mixture was stirred at 25° C. for 12 hours. After that, chlorodimethylsilane (1.5 g) was added, and the mixture was stirred at 25° C. for 1 hour. After performing extraction with hexane and water, volatiles were removed by distillation under a reduced pressure. 3.7 g of a compound (17) was obtained by performing flash column chromatography using silica gel (developing solvent: hexane/ethyl acetate) for the crude solution. The average value of n in the compound (17) was 17. The structure of the compound (17) was confirmed from NMR data shown below.

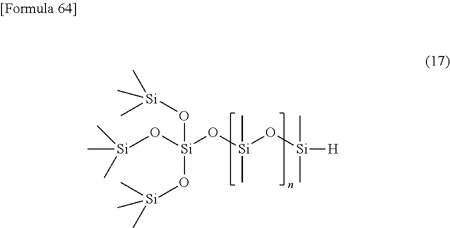

¹H-NMR (400 MHz, CDCl₃) δ4.68-4.52 (m, J=2.9 Hz, 1H), 0.15-0.06 (m, 6H), 0.05-0.06 (m, 129H).

### [Synthesis of Compound (18)]

Hexamethoxydisiloxane (10 g) and toluene (10 g) were added to the compound (17) (1 g), and the mixture was stirred until it became homogeneous. Next, tris (pentafluorophenyl) borane (0.06 g) was added to the resultant solution, and the mixture was stirred at 35° C. for 2 hours. 1.1 g of a compound (18) was obtained by removing the solvent and unreacted hexamethoxydisiloxane by distillation under a reduced pressure. The average value of n in the compound (18) was 17. The structure of the compound (18) was confirmed from NMR data shown below.

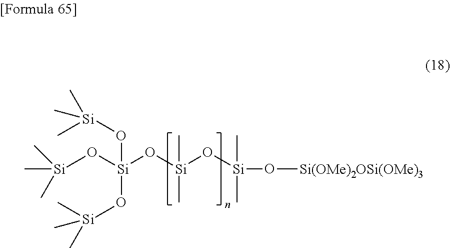

¹H-NMR (400 MHz, CDCl₃) δ3.76-3.26 (m, 15H), 0.25-0.16 (m, 135H).

### [Synthesis of Compound (19)]

A compound (19) was obtained according to a method disclosed in International Patent Publication No. WO 2024/34669.

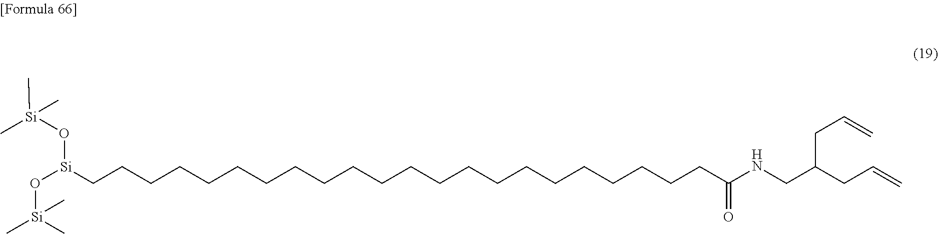

### [Synthesis of Compound (20)]

A toluene solution of a platinum/1,3-divinyl-1,1,3,3-tetramethyldisiloxane complex (platinum content: 3 mass %, 4.1 mg), aniline (2.6 mg), and the compound (14) (0.82 g) were added to the compound (19) (0.68 g) dissolved in dichloromethane (10 g), and the mixture was stirred at 50° C. for 2 hours. 1.14 g of a compound (20) was obtained by removing the solvent by distillation under a reduced pressure. The structure of the compound (20) was confirmed from NMR data shown below.

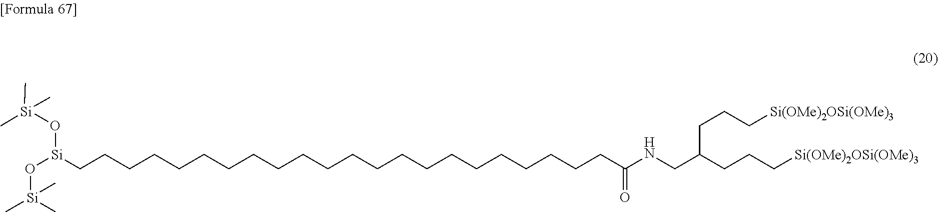

¹H-NMR (400 MHz, CDCl₃) δ 3.56 (d, J=16.1 Hz, 30H), 3.03 (t, J=5.6 Hz, 2H), 2.19 (t J=8.5 Hz, 2H), 1.76-0.86 (m, 49H), 0.80-0.47 (m, 6H), 0.05-0.06 (m, 21H).

### [Synthesis of Compound (21)]

Dichloromethane (10 g), 1,1,1,3,3,5,5-heptamethyltrisiloxane (15 g), and a toluene solution of a platinum/1,3-divinyl-1,1,3,3-tetramethyldisiloxane complex (platinum content: 3 mass %, 50 mg) were added to 18-bromo-1-octadecene (10 g), and the mixture was stirred at 25° C. for 24 hours. 14 g of a compound (21) was obtained by removing volatiles by distillation under a reduced pressure, and then performing flash column chromatography using silica gel (developing solvent: hexane/dichloromethane). The structure of the compound (21) was confirmed from NMR data shown below.

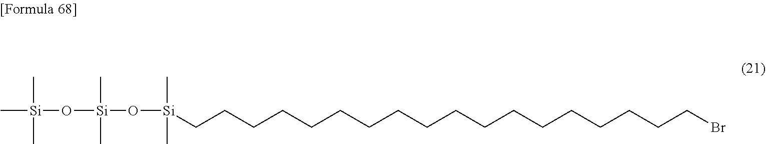 [SMILES: C[Si](C)(C)O[Si](C)(C)O[Si](C)(C)CCCCCCCCCCCCCCCCCCBr]

¹H-NMR (400 MHz, CDCl₃) δ 3.41 (t, J=6.9 Hz, 2H), 1.85 (dt, J=14.5, 7.0 Hz, 2H), 1.54-1.00 (m, 30H), 0.53 (dd, J=9.4, 5.9 Hz, 2H), 0.25-−0.33 (m, 21H).

### [Synthesis of Compound (22)]

THF (20 g) and magnesium (1.1 g) were added to 11-bromo-1-undecene (10 g), and the mixture was stirred at 60° C. for 2 hours. 30 g of a compound (22) was obtained by filtrating the reaction solution. It was confirmed that the concentration of the product was 0.8 M by titration using 1,10-phenanthroline.

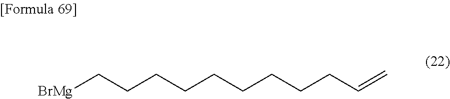

### [Synthesis of Compound (23)]

THF (10 g), the compound (22) (0.8 M) (10 mL), and copper (11) chloride (0.05 g) were added to the compound (21) (1 g), and the mixture was stirred at 60° C. for 24 hours. Extraction was performed by adding hydrochloric acid and hexane, and volatiles were removed by distillation under a reduced pressure. Then, 0.4 g of a compound (23) was obtained by performing flash column chromatography using 10% silver nitrate silica gel (developing solvent: hexane/dichloromethane). The structure of the compound (23) was confirmed from NMR data shown below.

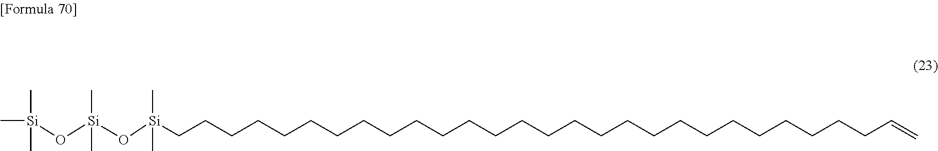 [SMILES: C=CCCCCCCCCCCCCCCCCCCCCCCCCCCC[Si](C)(C)O[Si](C)(C)O[Si](C)(C)C]

¹H-NMR (400 MHz, CDCl₃) δ 5.82 (ddt, J=16.9, 10.2, 6.7 Hz, 1H), 5.10-4.81 (m, 2H), 2.12-1.90 (m, 2H), 1.54-1.00 (m, 50H), 0.52 (t, J=7.7 Hz, 2H), 0.25-−0.33 (m, 21H).

### [Synthesis of Compound (24)]

A toluene solution of a platinum/1,3-divinyl-1,1,3,3-tetramethyldisiloxane complex (platinum content: 3 mass %, 4.1 mg), aniline (2.6 mg), and the compound (14) (0.72 g) were added to the compound (23) (0.55 g) dissolved in dichloromethane (10 g), and the mixture was stirred at 50° C. for 2 hours. 1.14 g of a compound (24) was obtained by removing the solvent by distillation under a reduced pressure. The structure of the compound (24) was confirmed from NMR data shown below.

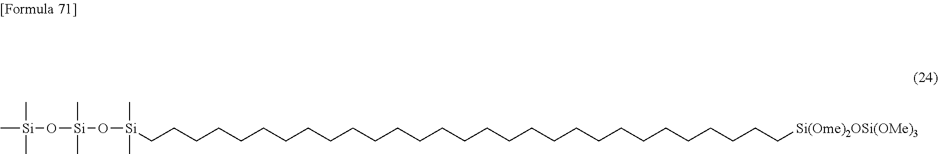

¹H-NMR (400 MHz, CDCl₃) δ 3.56 (d, J=16.1 Hz, 1511), 1.63-1.04 (m, 54H), 0.81-0.43 (m, 4H), 0.25-−0.33 (m, 21H).

### [Synthesis of Compound (25)]

Hexamethoxydisiloxane (10 g) and toluene (10 g) were added to MONODISPERSE HYDRIDE TERMINATED POLYDIMETHYLSILOXANE, 50 cSt (manufactured by Cerest, Inc., Product Code: DMS-HM15) (1.0 g), and the mixture was stirred until it became homogeneous. Next, tris (pentafluorophenyl) borane (0.06 g) was added to the resultant solution, and the mixture was stirred at 35° C. for 2 hours. 1.4 g of a compound (25) was obtained by removing the solvent and unreacted hexamethoxydisiloxane by distillation under a reduced pressure. The average value of n in the compound (25) was 45. The structure of the compound (25) was confirmed from NMR data shown below.

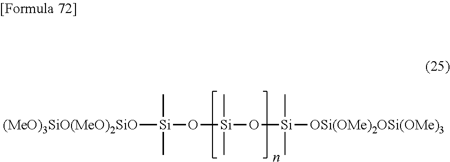

¹H-NMR (400 MHz, CDCl₃) δ 3.57 (d, J=6.2 Hz, 30H), 0.25-−0.33 (m, 282H).

### [Manufacturing of Article]

Articles according to Examples 1 to 7 were obtained by treating the surfaces of respective substrates in a method described below by using the compounds (12), (13), (15), (18), (20), (24) and (25), respectively. A wet-coating method was used as the surface treatment method.

30 g of silicon oxide was disposed as a vapor-deposition source on a copper hearth in a vacuum vapor-deposition apparatus (“VTR-350M” manufactured by ULVAC KIKO, Inc.). A glass substrate was disposed in the vacuum vapor-deposition apparatus, and the vacuum vapor-deposition apparatus was evacuated of air so that the pressure inside the apparatus became 5×10⁻³ Pa or lower. A substrate including a silicon oxide layer having a thickness of about 20 nm was manufactured by heating the aforementioned hearth to about 2,000° C. and thereby vacuum-depositing silicon oxide on the surface of the substrate.

The substrate including the silicon oxide layer was placed on the sample stage of a spray coater (API-90RS manufactured by APEIROS) in such a manner that the silicon oxide layer faces upward. Next, for each of the above-described compounds, a heptane solution (13 g) containing 0.2 mass % of the compound was fed into the syringe of the spray coater and was sprayed and applied at an atomization pressure of 130 kPa, a distance between the nozzle and the sample surface of 50 mm, and a scanning speed of 300 mm/sec (wet-coating method). After that, the substrate with the silicon oxide layer, of which the compound had been applied to the surface, was heat-treated at 140° C. for 30 minutes. By doing so, for each of Examples 1 to 7, an evaluation sample (article), in which the substrate, the silicon oxide layer, and the surface-treated layer were laminated in this order, was obtained.

### [Evaluations]

### <Water Repellency>

About 2 μL of distilled water was dropped on the surface-treated layer of the article, and the initial water contact angle was measured by using a contact angle measuring apparatus (product name: DM-500 manufactured by Kyowa Interface Science Co., Lid). An average value of values measured at five points on the surface-treated layer was defined as the water contact angle. The water repellency of the surface-treated layer was evaluated based on criteria shown below. Note that a 20 method was used for the calculation of the water contact angle.
A: The initial water contact angle is 105° or larger
C: The initial water contact angle is smaller than 105°.

### <Abrasion Resistance (Steel Wool)>

A steel wool Bonstar (#0000) was reciprocated 10,000 times on the surface-treated layer at a pressure of 98.07 kPa and a speed of 320 cm/min according to JIS L0849: 2013 (ISO: 105-X12: 2001) by using a reciprocating-type traverse tester (manufactured by KNT), and then, the water contact angle was measured. The method for measuring the water contact angle after the friction test was the same as that for the initial contact angle in the method for evaluating the water repellency. The smaller the decrease in the water repellency (water contact angle) after the friction is, the smaller the decrease in the performance caused by the friction is, and hence the more excellent the abrasion resistance is. The evaluation criteria are as follows.

Decrease in water contact angle=(Initial water contact angle)−(Water contact angle after friction)
A: The decrease in water contact angle after 10,000 reciprocations is 3° or smaller
B: The decrease in water contact angle after 10,000 reciprocations is larger than 3° and is 5° or smaller
C: The decrease in water contact angle after 10,000 reciprocations is larger than 5°

### <Fingerprint Removal Property>

A weight of 1 kg equipped with a red rubber stopper having a diameter of 2 cm, which served as a fingerprint stamp part, was prepared. Next, 70 μL of an artificial fingerprint liquid (manufactured by ISEKYU) was dropped onto a wiping cloth, and the fingerprint stamp was made to adhere to the artificial fingerprint liquid for 1 minute. The fingerprint stamp was made to adhere to a new wiping cloth for 20 seconds in order to remove an excessive artificial fingerprint liquid that had adhered to the fingerprint stamp. After that, an article in which a surface-treated layer was formed was placed on a hot plate of which the temperature was adjusted to 23° C. The fingerprint stamp was stamped on the surface-treated layer. The article to which the artificial fingerprint liquid adhered was placed on a sliding apparatus (product name “HHS-2000” manufactured by Shinto Scientific Co., Ltd.). A planar indenter having an area of 1 cm square was stuck on a wiping cloth (Savina Minimax manufactured by KB Seiren Ltd.) by using a double-sided tape, and the wiping cloth with the indenter stuck thereon was placed on the sliding apparatus. The artificial fingerprint liquid adhered to the surface-treated layer was wiped off by moving the wiping cloth thereon in one direction with a load of 100 g. The haze of the wiped area was measured with a haze meter (product name “NDH7000SP” manufactured by Denshoku Industries Co., Ltd.). The evaluation criteria were as follows.
A: The haze value is lower than 0.1%
B: The haze value is equal to or higher than 0.1% and is lower than 1%
C: The haze value is equal to or higher than 1%

### <Light Stability>

The surface-treated layer was irradiated with a light beam (650 W/m², 300 to 700 nm) at a black-panel temperature of 63° C. for 500 hours by using a tabletop xenon arc lamp-type accelerated light-stability testing machine (SUNTEST XLS+: product name, manufactured by Toyo Seiki Kogyo Co. Ltd), and then the water contact angle of the surface-treated layer was measured by the method described above. The smaller the decrease in the water contact angle after the accelerated light-stability test is, the smaller the decrease in the performance due to the light is, and hence the more excellent the light stability of the surface-treated layer is. The evaluation criteria are as follows. Decrease in water contact angle=(Initial water contact angle)−(Water contact angle after accelerated light-stability test)
A: The decrease in water contact angle after the accelerated light-stability test is 3° or smaller
B: The decrease in water contact angle after the accelerated light-stability test is larger than 3° and is 5° or smaller
C: The decrease in water contact angle after the accelerated light-stability test is larger than 5°

TABLE 1

| | | Example 1 | Example 2 | Example 3 | Example 4 | Example 5 | Example 6 | Example 7 |
|---|---|---|---|---|---|---|---|---|
| Conpound number | | (12) | (13) | (15) | (18) | (20) | (24) | (25) |
| Dry coating | Initial contact angle: Water | A | A | A | A | A | A | A |
| | Abrasion resistance | B | C | A | A | A | A | A |
| | Fingerprint removal property | B | B | A | A | A | A | A |
| | Light stability | C | B | A | A | A | A | A |

As shown in Table 1, it has been confirmed that each of the compounds according to Examples 3 to 7, in which they had the group P, makes it possible to form a surface-treated layer with excellent abrasion resistance compared with the compounds according to Examples 1 and 2, in which they had similar structures but did not have the group P. Further, it has also been confirmed that each of the compounds according to Examples 3 to 7 makes it possible to form a surface-treated layer with an excellent fingerprint removal property and excellent light stability compared with the compounds according to Examples 1 and 2.

A compound according to the present disclosure is useful as a surface treatment agent. Such a surface treatment agent can be used, for example, for substrates in display devices such as touch panel displays, optical elements, semiconductor elements, building materials, automobile components, and nanoimprinting technologies. Further, such a surface treatment agent can be used for bodies, window glasses (front glasses, side glasses, and rear glasses), mirrors, bumpers, and the like in transportation apparatuses such as trains, automobiles, ships, and airplanes. Further, such a surface treatment agent can be used for exterior walls of buildings, tents, photovoltaic modules, sound insulating plates, and outdoor articles such as concrete; and fishing nets, sweep nets, and water tanks. Further, such a surface treatment agent can be used for kitchens, bathrooms, washstands, mirrors, and toiletry components; chandeliers and ceramics such as tiles; and artificial marble and various indoor apparatuses such as air conditioners. Further, such a surface treatment agent can be used for antifouling treatments of jigs, inner walls, pipes, and the like in factories. Further, such a surface treatment agent can be used for goggles, glasses, helmets, pachinko, fibers, umbrellas, play equipment, and soccer balls. Further, such a surface treatment agent can be used as adherents for various packaging materials such as packaging materials for foods, packaging materials for cosmetics, and the interior of pots. Further, such a surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

These embodiments can be combined as desirable by one of ordinary skill in the art. From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound comprising:
a group P shown below; and
an organopolysiloxane residue, 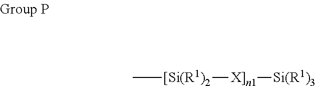
where
each X is independently an oxygen atom or a carbon atom,
each R¹ is independently a hydrolyzable group, a group having a hydrolyzable group, a hydroxyl group, or a hydrocarbon group,
at least four of R¹ are hydrolyzable groups, groups having a hydrolyzable group, or hydroxyl groups, and
n1 is an integer of 1 to 3.

2. The compound according to claim 1, wherein n1 is 1.

3. The compound according to claim 1, wherein
the group P is —[Si(OR²)₂—O]ₙ₁—Si(OR²)₃,
where
each R² is independently a hydrocarbon group.

4. The compound according to claim 2, wherein
the group P is —Si(OR²)₂—O—Si(OR²)₃,
where
each R² is independently a hydrocarbon group.

5. A compound represented by Formula (1) or Formula (2) shown below, 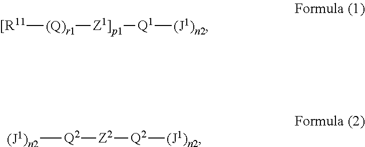
where
each J¹ is independently a group P shown below,
Group P: —[Si(R¹)₂—X]ₙ₁—Si(R¹)₃
each X is independently an oxygen atom or a carbon atom,
each R¹ is independently a hydrolyzable group, a group having a hydrolyzable group, a hydroxyl group, or a hydrocarbon group,
at least four of the R¹ groups are hydrolyzable groups, groups having a hydrolyzable group, or hydroxyl groups, and
n1 is an integer of 1 to 3,
each R¹¹ is independently (R¹¹¹)₃Si—, a linear organopolysiloxane residue, a cyclic organopolysiloxane residue, or a cage-like organopolysiloxane residue,
each R¹¹¹ is independently a hydrocarbon group or a trialkylsilyloxy group,
each Q is independently —O— or —OC(═O)—,
each r1 is independently 0 or 1,
each Z¹ is independently a single bond, an alkylene group which may have an etheric oxygen atom, an organopolysiloxane group, or a combination of an alkylene group which may have an etheric oxygen atom and an organopolysiloxane group,
Z² is an organopolysiloxane group or a combination of an alkylene group which may have an etheric oxygen atom and an organopolysiloxane group,
Q¹ is a linking group having a valency of (p1+n2),
each Q² is independently a linking group having a valency of (1+n2),
p1 is an integer of 1 or greater, and
each n2 is independently an integer of 1 or greater.

6. The compound according to claim 5, wherein n2 is an integer of 1 to 3.

7. The compound according to claim 5, wherein Z¹ is —(Si(R⁸)₂—O)ₘ—Si(R⁸)₂—,
where
each R¹ is independently a hydrocarbon group, and
n is a number of 1 or greater.

8. The compound according to claim 5, wherein
Z² is —(Si(R¹)₂—O)ₘ—Si(R¹)₂—,
where
each R¹ is independently a hydrocarbon group, and
m is a number of 1 or greater.

9. A composition comprising a compound according to claim 1 and a liquid medium.

10. A surface treatment agent comprising a compound according to claim 1.

11. A surface treatment agent comprising a compound according to claim 1 and a liquid medium.

12. A method for manufacturing an article including a surface-treated layer formed on a substrate by performing a surface treatment on the substrate by using a surface treatment agent comprising a compound according to claim 1.

13. An article comprising a substrate, and a surface-treated layer disposed on the substrate, a surface of the surface-treated layer being treated with a surface treatment agent comprising a compound according to claim 1.

14. The article according to claim 13, wherein the article is an optical member.

15. The article according to claim 13, wherein the article is a display or a touch panel.

16. An intermediate represented by the following Formula (3): 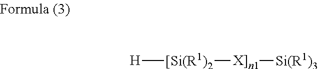
wherein
each X is independently an oxygen atom or a carbon atom,
each R¹ is independently a hydrolyzable group, a group having a hydrolyzable group, a hydroxyl group, or a hydrocarbon group,
at least four of the R¹ are hydrolyzable groups, groups having a hydrolyzable group, or hydroxyl groups, and
n1 is an integer from 1 to 3.

17. The intermediate according to claim 16, wherein n1 is 1.
